(19) United States
(12) Patent Application Publication
(10) Pub. No.: US 2023/0023731 A1
(43) Pub. Date: Jan. 26, 2023

(54) SYSTEMS, METHODS, AND ARTICLES FOR OPTIMIZING CLEARANCE OF CONTENT

(71) Applicant: WideOrbit LLC, San Francisco, CA (US)

(72) Inventors: William E. Offeman, Redmond, WA (US); Brian Thoman, Snohomish, WA (US); Francisco Lopez Alvarez, Woodinville, WA (US); Trevan Grant Zosel, Bothell, WA (US)

(21) Appl. No.: 17/858,932

(22) Filed: Jul. 6, 2022

Related U.S. Application Data
(60) Provisional application No. 63/220,359, filed on Jul. 9, 2021.

(51) Int. Cl. G06Q 30/02

(52) U.S. Cl. CPC G06Q 30/0273; G06Q 30/0206

(57) ABSTRACT

Systems, methods and articles for optimizing the clearance of content, such as advertisements. The systems disclosed herein provide a greater chance that offers to buy advertisement placement opportunities from media providers are accepted by the media providers. This is achieved by matching advertisements to advertisement placement opportunities which match buyer goals and provider goals, and by using historical data related to advertisements that the seller has cleared. The system may optimize clearance for multiple buyers which are competing for the same advertisement placement opportunities at the same time.

### CROSS REFERENCE TO RELATED APPLICATIONS

This patent application claims priority from U.S. provisional patent application Ser. No. 63/220,359 titled “SYSTEMS, METHODS, AND ARTICLES FOR OPTIMIZING CLEARANCE OF CONTENT” filed on Jul. 9, 2021. In cases where the present application conflicts with a document incorporated by reference, the present application controls.

### BACKGROUND

### Technical Field

The present disclosure relates the field of computer technology, and more particularly, to computer systems and methods that facilitate the delivery of content to consumers.

### Description of the Related Art

Content providers such as radio stations and networks, television stations and networks, and Webcasters provide programming including content which is the subject of programming. Content providers' delivery of content is often via broadcasts or Webcasts (collectively, “mediacasts”). While content providers may employ repeaters and the like, broadcasts are typically limited in range to a geographic region.

Programming often includes advertisements interspersed with the subject matter of the programming. The advertisements may occur in segments or slots sometimes referred to as “ad breaks.” Content providers typically sell advertising time to generate revenue to fund operation, as well as generate profits, where the content provider is a commercial entity rather than a nonprofit entity. Advertisers typically offer to buy this advertising time to advertise their products or services. For example, Advertiser A may offer Content Provider B $1000 to buy advertisement time played during Television Show C.

New approaches that automate the various activities related to buying, selling and placement of new materials, for instance, advertisements, in mediacasts are desirable.

### BRIEF SUMMARY

A method of operating a computer system to optimize clearance of advertisements may be summarized as including receiving an indication of one or more advertisements, each advertisement including one or more advertisement placement attributes; calculating a price for each advertisement based on the one or more advertisement placement attributes; receiving media content provider information for a media content provider, the media content provider information including identification of a plurality of media content segments; receiving audience data for the media content provider, the audience data including an audience prediction for each media content segment of the plurality of media content segments; identifying one or more advertisement placement opportunities for each media content segment of the plurality of media content segments;

assigning a weight to each flight range of a plurality of flight ranges; and iterating through each flight range based on the assigned weight, including, for each flight range of the plurality of flight ranges: dividing the flight range into a plurality of content segment collections, each content segment collection including at least one media content segment of the plurality of media content segments, each media content segment including at least one advertisement placement opportunity of the one or more advertisement placement opportunities; ranking each content segment collection of the plurality of content segment collections, wherein the rank for each content segment collection is determined based on at least one attribute of the at least one media content segments included in each content segment collection; and iterating through each content segment collection based on the rank, including, for each content segment collection of the plurality of content segment collections: calculating a price for each advertisement placement opportunity for the respective content segment collection based on the audience data and the media content provider information; determining a likelihood that a media content provider will accept the assignment of an advertisement of the one or more advertisements to an advertisement placement opportunity of the at least one advertisement placement opportunities of the content segment collection based, at least in part, on the calculated price of the advertisement and the calculated price of the advertisement placement opportunity; and assigning the advertisement of the one or more advertisements to at least one advertisement placement opportunity of the one or more advertisement placement opportunities for the content segment collection based on the determined likelihood that the media content provider will accept the assignment.

Each advertisement placement opportunity may comprise a spot rate, a capacity, and audience demographic data.

The method may further include calculating the price for each advertisement placement opportunity for the respective content segment collection by: calculating the price for the advertisement placement opportunity for the content segment collection based on the audience data, the spot rate, the capacity, the audience demographic data, and the media content provider information.

The advertisement placement attributes may further comprise at least one of a target demographic, a target number of impressions, a spot length, a total budget, a product code, one or more excluded media content providers, or one or more excluded media content segment collections.

The method may further include: generating the audience prediction for one or more media content segment collections based on the received audience data; and calculating the price for each advertisement placement opportunity for the respective content segment collection based on the audience data, the media content provider information, and the audience prediction.

The method may further include: identifying at least one advertisement of the one or more advertisements which are assigned to at least one advertisement placement opportunity of the one or more advertisement placement opportunities and which have not been accepted by a media content provider; and storing an indication of the identified at least one advertisement of the one or more advertisements in a holding tank.

Each flight range of the plurality of flight ranges may be one week, each content segment collection of the plurality of content segment collections may be a daypart, and each media content segment may be a program.

The method may further include receiving historical acceptance data; determining whether to soft accept the assignment of one or more assigned advertisements based on the historical acceptance data; and marking the one or more assigned advertisements as accepted based on the determination of whether to soft accept the assignment of the one or more assigned advertisements.

The method may further include receiving historical rejection data; determining whether to soft accept the assignment of one or more assigned advertisements based on the historical rejection data; and marking the one or more assigned advertisements as accepted based on the determination of whether to soft accept the assignment of the one or more assigned advertisements.

The method may further include: receiving historical acceptance data; receiving historical rejection data; determining whether to soft accept the assignment of one or more assigned advertisements based, at least in part, on the historical acceptance data and historical rejection data; and marking the one or more assigned advertisements as accepted based on the determination of whether to soft accept the assignment of the one or more assigned advertisements.

The method may further include presenting to a media content provider, via a media content provider-facing user interface, an option to soft reject the assignment of one or more assigned advertisements; obtaining user input, via the media content provider-facing user interface, indicating that at least one assigned advertisement of the one or more assigned advertisements is soft rejected; and marking the at least one assigned advertisement as rejected.

The method may further include presenting to a media content provider, via a media content provider-facing user interface, an option to soft accept the assignment of one or more assigned advertisements; obtaining user input, via the media content provider-facing user interface, indicating that at least one assigned advertisement of the one or more assigned advertisements is soft accepted; and marking the at least one assigned advertisement as accepted.

The method may further include determining whether one or more conditions have occurred, wherein the one or more conditions comprise at least one of: a determination that a provider of the at least one assigned advertisement has rejected the assignment of at least one advertisement of the at least one assigned advertisements; a determination that a price of at least one advertisement has changed; or a determination that at least one additional advertisement has been received; and unmarking the at least one assigned advertisement as accepted, such that the at least one assigned advertisement is able to be re-assigned to at least one advertisement placement opportunity.

The method may further include identifying a current flight range of the plurality of flight ranges, wherein the current flight range occurs before each of the other flight ranges in the plurality of flight ranges; presenting to a media content provider, via a media content provider-facing user interface, an option to mark at least one assignment of the one or more assigned advertisements included in a flight range which is not the current flight range as a preferred assignment; obtaining user input, via the media content provider-facing user interface, indicating that at least one assignment of the one or more assigned advertisements is a preferred assignment; and calculating the price for each advertisement placement opportunity for the respective content segment collection based on the audience data, the media content provider information, and the one or more preferred assignments.

The method may further include assigning a weight to each flight range of the plurality of flight ranges by: determining which flight ranges of the plurality of flight ranges will occur sooner than other flight ranges of the plurality of flight ranges; and adjusting the weights of each flight range based on the determination of which flight ranges of the plurality of flight ranges occur sooner than other flight ranges of the plurality of flight ranges.

The method may further include assigning an impression goal to each flight range based on the weight assigned to each of the flight ranges of the plurality of flight ranges.

The advertisement placement attributes may include a goal, and each content segment collection may be ranked based at least in part on the goal for each advertisement included in the content segment collection.

The method may further include: determining whether one or more assigned advertisements are accepted by the media content provider; extracting historical data from each advertisement placement opportunity of the one or more assigned advertisements accepted by the media content provider; and determining the likelihood that the media content provider will accept the assignment of an advertisement to an advertisement placement opportunity based on at least the extracted historical data, the calculated price of the advertisement, and the calculated price of the advertisement placement opportunity.

The method may further include calculating the price of the advertisement placement opportunity based on a CPM of the advertisement placement opportunity; obtaining a rate guidance from a media content provider; and determining the likelihood that the media content provider will accept the assignment of an advertisement to an advertisement placement opportunity based on at least the rate guidance, the calculated price of the advertisement, and the calculated price of the advertisement placement opportunity.

The method may further include identifying a spot rate for each advertisement placement opportunity; identifying a spot rate for each advertisement, based on at least the advertisement placement attributes; and ranking each advertisement placement opportunity based on the identified spot rate for the advertisement placement opportunity and the identified spot rate for each advertisement, such that advertisement placement opportunities with a higher rank are more likely to be assigned an advertisement.

Ranking each advertisement placement opportunity may further include: determining whether the spot rate for each advertisement is within a determined range of the spot rate for each advertisement placement opportunity, such that the advertisement placement opportunity is ranked higher based on a determination that the spot rate for the advertisement is within the determined range.

Iterating through each flight range may further include: determining a goal for each flight range, wherein the goal for each flight range includes obtaining a threshold number of impressions; identifying one or more advertisements not assigned to an advertisement placement opportunity; identifying one or more content segment collections with advertisement placement opportunities that are not assigned to an advertisement; re-ranking the one or more content segment collections; and iterating through each content segment collection to assign an advertisement of the one or more advertisements not assigned to an advertisement placement opportunity to an advertisement placement opportunity not assigned to an advertisement.

The method may further include: determining a predicted rate of clearance for each assigned advertisement based on the advertisement placement attributes for the assigned advertisement and the media content provider information; and present the predicted rate of clearance for at least one of the assigned advertisements to a user via an advertiser-facing user interface.

The method may further include: presenting, via a media content provider-facing user interface, an option to soft accept one or more flight ranges of the plurality of flight ranges, wherein soft accepting the flight range includes soft accepting the assigned advertisements for advertisement placement opportunities in the flight range; receiving user input, via the media content provider-facing user interface, an indication of one or more flight ranges which are soft accepted; determining which flight ranges are not soft accepted; and re-iterating through each flight range which is not soft accepted.

The method may further include: receiving second media content provider information for one or more additional media content providers; receiving audience data for each media content provider of the one or more additional media content providers; and identifying one or more advertisement placement opportunities for a plurality of media content segment collections for each media content provider of the additional media content providers.

Ranking the content collections may further include: identifying one or more target demographics of each media content segment; and ranking the content collections based at least in part on the one or more target demographics of each media content segment.

A system used to optimize clearance of advertisements in linear mediacasts, may comprise: at least one nontransitory processor-readable storage medium that stores at least one of instructions or data; and at least one processor communicatively coupled to the at least one nontransitory processor-readable storage medium, in operation, the at least one processor: receives an indication of one or more advertisements, each advertisement including one or more advertisement placement attributes; calculates a price for each advertisement based on the one or more advertisement placement attributes; receives media content provider information for a media content provider, the media content provider information including identification of a plurality of media content segments; receives audience data for the media content provider, the audience data including an audience prediction for each media content segment of the plurality of media content segments; identifies one or more advertisement placement opportunities for each media content segment of the plurality of media content segments; assigns a weight to each flight range of a plurality of flight ranges; and iterates through each flight range based on the assigned weight, including, for each flight range of the plurality of flight ranges: divides the flight range into a plurality of content segment collections, each content segment collection including at least one media content segment of the plurality of media content segments, the at least one media content segment including at least one advertisement placement opportunity of the one or more advertisement placement opportunities; ranks each content segment collection of the plurality of content segment collections, wherein the rank for each content segment collection is determined based on at least one attribute of the at least one media content segments included in each content segment collection; and iterates through each content segment collection based on the rank, including, for each content segment collection of the plurality of content segment collections: calculates a price for each advertisement placement opportunity for the respective content segment collection based on the audience data and the media content provider information; determining a likelihood that a media content provider will accept the assignment of an advertisement of the one or more advertisements to an advertisement placement opportunity of the at least one advertisement placement opportunities of the content segment collection based, at least in part, on the calculated price of the advertisement and the calculated price of the advertisement placement opportunity; and assigns the advertisement of the one or more advertisements to at least one advertisement placement opportunity of the one or more advertisement placement opportunities for the content segment collection based on the determined likelihood that the media content provider will accept the assignment.

A nontransitory processor-readable storage medium may store at least one of instructions or data, the instructions or data, when executed by at least one processor, may cause the at least one processor to: receive an indication of one or more advertisements, each advertisement including one or more advertisement placement attributes; calculate a price for each advertisement based on the one or more advertisement placement attributes; receive media content provider information for a media content provider, the media content provider information including identification of a plurality of media content segments; receive audience data for the media content provider, the audience data including an audience prediction for each media content segment of the plurality of media content segments; identify one or more advertisement placement opportunities for each media content segment of the plurality of media content segments; assign a weight to each flight range of a plurality of flight ranges; and iterate through each flight range based on the assigned weight, including, for each flight range of the plurality of flight ranges: divide the flight range into a plurality of content segment collections, each content segment collection including at least one media content segment of the plurality of media content segments, the at least one media content segment including at least one advertisement placement opportunity of the one or more advertisement placement opportunities; rank each content segment collection of the plurality of content segment collections, wherein the rank for each content segment collection is determined based at least one attribute of the at least one media content segments included in each content segment collection; and iterate through each content segment collection based on the rank, including, for each content segment collection of the plurality of content segment collections: calculate a price for each advertisement placement opportunity for the respective content segment collection based on the audience data and the media content provider information; determine a likelihood that a media content provider will accept the assignment of an advertisement of the one or more advertisements to an advertisement placement opportunity of the at least one advertisement placement opportunities of the content segment collection based, at least in part, on the calculated price of the advertisement and the calculated price of the advertisement placement opportunity; and assign the advertisement of the one or more advertisements to at least one advertisement placement opportunity of the one or more advertisement placement opportunities for the content segment collection based on the determined likelihood that the media content provider will accept the assignment.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 shows an example networked environment according to one illustrated implementation in which various apparatus, methods and articles described herein may operate.

FIG. 2 is a block diagram showing sample elements of a clearance optimizer system, according to one illustrated implementation.

FIG. 3 is a flow diagram showing a method of operating a clearance optimization engine to assign advertisements to advertisement placement opportunities to ensure that the advertisements clear, according to one non-limiting illustrated implementation.

FIG. 4 is a flow diagram showing a method of operating a clearance optimization engine to iterate through a plurality of flight ranges to assign an advertisement to an advertisement placement opportunity, according to one non-limiting illustrated implementation.

FIG. 5 is a flow diagram showing a method of operating a clearance optimization engine to iterate through a plurality of content segment collections to assign an advertisement to an advertisement placement opportunity, according to one non-limiting illustrated implementation.

FIG. 6 is a flow diagram showing a method of operating a clearance optimization engine to assign a rank to each content segment collection, according to one non-limiting illustrated implementation.

FIG. 7 is a flow diagram showing a method of operating a clearance optimization engine to assign an advertisement to an advertisement placement opportunity in a content segment collection, according to one non-limiting illustrated implementation.

FIG. 8 is a flow diagram showing a method of operating a clearance optimization engine to assign advertisements from multiple buyers to advertisement placement opportunities provided by multiple sellers, according to one non-limiting illustrated implementation.

FIG. 9 is a flow diagram showing a method of operating a clearance optimization engine to iterate through content segment collections to optimize assigned advertisements, according to one non-limiting illustrated implementation.

FIG. 10 is a flow diagram showing a method of operating a clearance optimization engine to reallocate advertisements to other advertisement placement opportunities, according to one non-limiting illustrated implementation.

FIG. 11 is a flow diagram showing a method used by the clearance optimization engine to generate a prediction of whether an advertisement assigned to an advertisement placement opportunity will clear, according to one non-limiting illustrated implementation.

FIG. 12 is a display diagram depicting a sample seller rate definition screen presented by the PFI, according to one non-limiting illustrated implementation.

FIG. 13 is a display diagram depicting a sample buyer campaign definition screen presented by the AFI, according to one non-limiting illustrated implementation.

FIG. 14 is a display diagram depicting a sample buyer goal screen presented by the AFI, according to one non-limiting illustrated implementation.

FIG. 15 is a display diagram depicting a sample assignment acceptance screen presented by the PFI, according to one non-limiting illustrated implementation.

FIG. 16 is a display diagram depicting a sample campaign progress dashboard presented by the AFI, according to one non-limiting illustrated implementation.

FIG. 17 shows a processor-based device suitable for implementing the various functionality described herein.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

One or more implementations of the present disclosure are directed to computer-implemented systems and methods of automating and optimizing the buying and selling of advertisements, or “spots.” Buying and selling television, radio or digital advertising has traditionally been a highly manual process and requires many participants to execute orders. Layering in audience and pricing data adds another level of complexity to the campaign execution workflow.

In conventional workflows, an advertiser, or “buyer”, contacts multiple networks, or “media content providers,” to negotiate and purchase spots. The advertiser may negotiate a price with each of these providers, only to find out later on that one or more of the media content providers have rejected their offers, resulting in wasted time, effort, and, in the case of negotiations and purchases that use computer systems or automation, computer resources.

An advertisement is “cleared” when a buyer's offer to buy a spot is accepted by a seller, or media content provider and the buyer's advertisement is published in the spot. However, media content providers typically receive multiple offers from multiple buyers for each spot, which results in wasted resources and effort from both buyers and sellers in selling spots. Thus, there is no guarantee that a media content provider will accept an offer to buy a spot from a buyer, and no guarantee that the advertisement will clear. Furthermore, while some conventional techniques raise the clearance rate for advertisements, these techniques often work solely on the buyer side or seller side, and thus cannot optimize clearing advertisements for both the buyer and seller. Additionally, because these techniques are only able to gather data regarding a buyer or a seller, they are unable to efficiently and reliably optimize clearing the advertisements.

Implementations of the present disclosure are directed to computer-implemented systems and methods for guaranteed clearance of content, such as advertisements, which optimizes placement of the content for both the buyer and the seller. Thus, the aforementioned inefficient and unreliable processes is improved to provide optimization that was previously not possible using conventional workflows.

Such implementations are thus able to improve the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks.

For example, a buyer uses a vast amount of computing power to optimize offers for advertisement placement opportunities, because they typically contact many media content providers for many different advertisements, dayparts, etc. Each additional media content provider, and each additional advertisement, increases the complexity of optimizing the offers exponentially. Thus, re-optimizing a buyer's offers for advertisement placement opportunities after the advertisements do not clear requires the use of a vast amount of additional computer resources to re-optimize the buyer's campaign and transmit additional offers for advertisement placement opportunities. However, by ensuring the buyer's offers have a high likelihood of clearing, the described implementations are able to reduce the likelihood that additional re-optimization is needed by ensuring that the offers clear in the first instance, thus reducing the computing power necessary to re-optimize a buyer's campaign and offers for advertisement placement opportunities.

In at least some implementations, buyers and sellers can trade mediacast (e.g., broadcast, Webcast) advertisement inventory (e.g., direct or programmatically) at local, national, and/or worldwide levels. The types of media traded via may simultaneously include numerous types of media, including TV, cable, satellite, radio, outdoor, display, digital, print, etc. Such programmatic advertising implements data-driven automation of audience-based advertising operations which inverts the industry standard in which marketers rely on show ratings to determine desirable audiences for the marketers' advertisements.

In at least some implementations, the clearance optimization systems disclosed herein interface with demand side platforms (DSPs) that optimize offers to guarantee that an advertisement will clear. Sellers enjoy seamless transaction workflow for getting advertisements from proposal, to publishing, and to billing that delivers a significant reduction in time spent on reconciliation and “make-goods” and streamlines processes for creative management and revenue management across direct and programmatic sales channels.

The clearance optimization systems may include a seller side platform (SSP) or console for sellers (e.g., broadcasters, Webcasters, printed content providers) and an advertiser-facing interface or console for demand side platform (DSP) entities to interface with the advertisement purchase systems. Through the SSP, sellers can access demand and make advertisement inventory available and accept or reject bid responses based on marketplace demand.

The advertiser-facing interface facilitates creative placement and reviewing for the buy side, and may have transcoding and approval tools for the sell side. For example, in some implementations, once an advertisement transaction is approved, the advertiser-facing interface sends the advertisement directly to a broadcaster's traffic system.

In some implementations, the clearance optimization systems disclosed herein automate aspects of billing, reconciliation, and creative execution. In some implementations, the clearance optimization systems may be integrated with advertisement management software and sales and traffic management systems.

In one or more implementations disclosed herein, the systems do not require sellers to offer particular day parts or times when advertisement inventory is available. That is, “carve-outs” are not required. Rather, buyers can extend offers for the entire roster or landscape for a particular channel for a particular period of time (e.g., mediacast day). Thus, sellers may peruse this demand and decide which offers to accept or not to accept.

In some implementations, the advertisement inventory is bought and sold as canonical inventory units which group similar but discrete advertisement slots together. For example, for linear media an inventory unit may be defined as a specific channel, day and time period (e.g., 30 minutes). Buyers may price the inventory units and provide a bid for any of the inventory units.

As discussed further below, a buyer may define an advertisement campaign with one or more goals, such as impression goals, budget goals, etc., and one or more advertisements. The goals may be goals for a specific period of time, such as a day, daypart, week, etc., goals for an entire campaign, goals for a portion of the campaign, etc. The clearance optimization systems disclosed herein receive advertisement placement opportunities within media content segments (i.e. inventory units) from sellers, and optimize the buyer campaign to raise the likelihood that the sellers will accept the offers from the buyers. The clearance optimization systems disclosed herein may additionally optimize the clearance rate between multiple buyers and multiple sellers competing for the same inventory units.

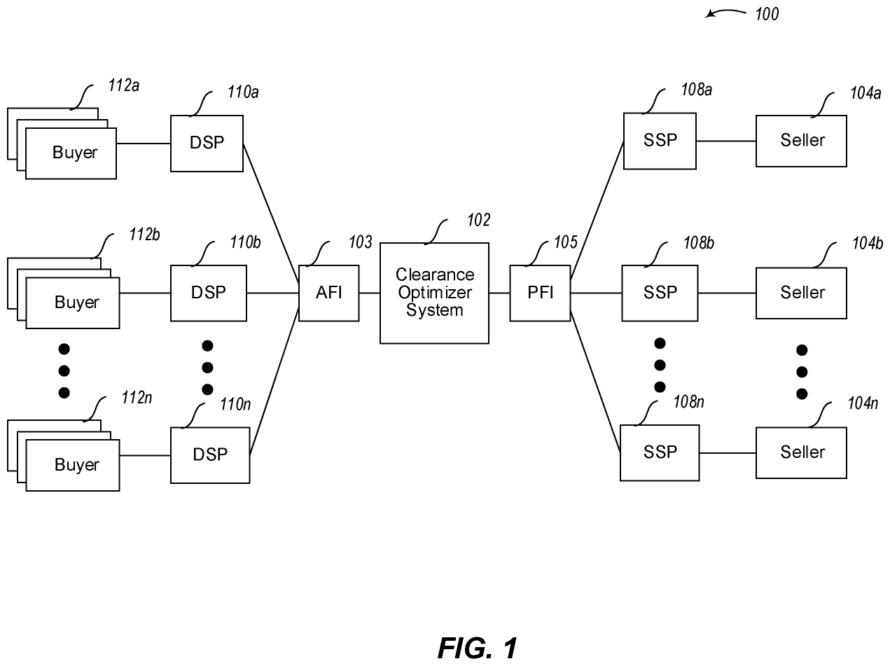

FIG. 1 shows an example networked environment 100 according to one illustrated implementation in which various apparatus, methods and articles described herein may operate. The environment 100 includes a clearance optimizer system 102 an advertiser-facing interface (AFI) 103, a media content provider-facing interface (PFI), a number of sellers or content providers 104A-104N (collectively 104), a number of seller side platforms (SSPs) 108A-108N (collectively 108), a number of demand side platforms (DSPs) 110A-110N (collectively 110), and a number of buyers 112A-112N (collectively 112), such as advertisers or agencies, all communicatively coupled by one or more networks or other communications channels. The various components of the environment may be distributed or integrated in any number of ways. For example, in at least some implementations, two or more of the DSPs 110, AFI 103, clearance optimizer system 102, and PFI 105 may be integrated into a single platform provided by one or more entities.

The sellers 104 may take a variety of forms, for example, radio stations or broadcasters, television stations or broadcasters, other terrestrial or satellite broadcasters or multicasters (not shown), Webcasters, printed content (e.g., print media) providers, outdoor content (e.g., billboards) providers, etc. The sellers 104 may, or may not, own the content that they provide. The sellers 104 utilize the PFI 105 to access the clearance optimizer system 102. On the buy side, the buyers 112 (e.g., advertisers, agencies) may interface with the system 102 via the AFI 103 through the buyers' respective DSPs 110.

With presently available systems, it is difficult for advertisers to ensure that their offers clear. Further, although media content providers have the final say in clearing an advertisement, there may be other advertisements which would be better for the spot. Additionally, when advertisements in a buyer's campaign do not clear, they must search for new spots, submit new offers, and re-optimize their campaign for those spots.

To address these and other issues, one or more implementations of the present disclosure predict a likelihood that an offer will clear, and assign advertisements to advertisement placement opportunities based, at least in part, on that prediction. The systems and methods disclosed herein are also able to assign advertisements based on clearance with respect to multiple media content providers and multiple buyers, thus ensuring that each media content provider is able to select the best advertisement for an advertisement placement opportunity, while still ensuring that each buyer's offer is accepted.

In an example implementation, a buyer 112a may create an advertisement campaign scheduled to run for four weeks by using an AFI 103. Likewise, sellers 104a and 104b may each define media content segments and advertisement placement opportunities for which they would like to buy advertisements. The clearance optimizer system 102 assigns the buyer's 112a advertisements to each of the advertisement placement opportunities based on a prediction of whether the sellers 104a and 104b will accept the assignment of the advertisements.

In another example implementation, where there are additional buyers, such as a buyer 112b, the clearance optimizer system 102 may individually assign advertisements for each of the buyer campaigns to the advertisement placement opportunities defined by the sellers. In this example, some advertisement placement opportunities may have multiple advertisements assigned, such that the advertisements are competing for the same advertisement placement opportunity. The clearance optimizer system 102 then reallocates the assignments of the advertisements to reduce the number of advertisement placement opportunities with competing advertisements based on predictions of whether the advertisements will clear. Thus, the clearance optimizer system 102 is able to optimize the offers for both the buyers and the sellers.

Furthermore, as the number of buyers and sellers increase, the complexity of the reallocation increases exponentially, such that it becomes impossible for a human to find an allocation of advertisements to advertisement placement opportunities which satisfies the goals of all of the buyers and the sellers.

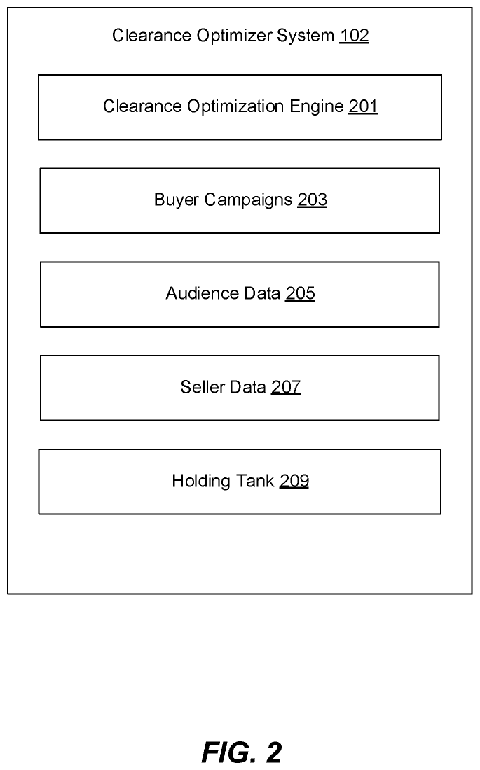

FIG. 2 is a block diagram showing sample elements of a clearance optimizer system 102, according to one illustrated implementation. The clearance optimizer system 102 includes a clearance optimization engine 201, one or more buyer campaigns data 203, audience data 205 for one or more media content segments, seller data 207 for one or more media content providers, and a holding tank 209. The clearance optimization engine 201 analyzes incoming advertisement data from buyer campaigns associated with the buyer campaigns data 203 and assigns advertisements included in the buyer campaigns data 203 to advertisement placement opportunities identified in the seller data 207. The clearance optimizer engine 201 may also use seller data 207 to predict whether a certain advertisement is likely to clear if it is assigned to a certain advertisement placement opportunity. Additionally, clearance optimizer engine 201 may use the audience data 205 to predict whether the advertisement is likely to clear.

The buyer campaigns data 203 includes data related to advertising campaigns and individual advertisements, such as attributes for the campaign, attributes for the advertisement (or “advertisement placement attributes”), or other data related to advertisements and advertisement campaigns, defined by the buyer. The data may include, for example: goals for a campaign, such as a target number of impressions, a budget, advertising across a wide variety of media content, a CPM goal, etc.; advertisement attributes for one or more advertisements, such as a target demographic, target number of impressions, a budget for the advertisements, preferred days, preferred day parts, excluded media content, excluded media content providers, and other attributes used to describe an offer for an advertisement spot; a target audience, or audiences; and other data describing the buyer or its requirements, goals, etc. In some implementations, the buyer campaigns data is obtain through an AFI 103.

The audience data 205 includes data related to the composition of an audience for media content segments. The audience data may include, for example, data describing demographic information for audiences which consume the media content segments, data describing the size of audiences which consume the media content segments, ratings data for media content segments, (e.g. Nielson ratings or other standardized or non-standardized content rating system), or other data describing an audience of a media content segment, content segment collection, etc. The clearance optimizer system 102 or clearance optimization engine 201 may use the audience data to predict audience data for an audience consuming the media content segment in the future. In some implementations, the clearance optimizer system 102 or clearance optimization engine 201 predicts the audience data by using an exponential moving average. In some implementations, the clearance optimizer system 102 or clearance optimization engine 201 predicts the audience data by using an A.I. or machine-learning model trained to predict audience data.

The seller data 207 includes data related to media content segments, advertisement placement opportunities, such as attributes for media content segments, attributes for advertisement placement opportunities, attributes for a media content provider, etc., and other data related to the seller. The seller data may include, for example: media content provider information, such as capacity for advertisements (such as a measure of the total inventory available), advertisement placement opportunities for each provider, data indicating one or more content segments, such as media content segments, published by the media content provider, and other information related to the media content provider; rates, such as a preferred rate, rate guidance (i.e. a range of rates which the provider would accept), or actual rate, for each advertisement placement opportunity; historical data related to the advertisement attributes of advertisements the media content provider has accepted an offer for (that is, advertisements that have cleared); data describing how often the inventory is sold out and what types of advertisements are cleared when the inventory is sold out, which may be included as part of the historical data; audience data describing the makeup of the audience which consumes the media content in the media content segment; and other information which may be obtained from, or is related to, a media content provider. In some implementations, a media content segment may have multiple audiences (for example, media content segment may have an audience made up of people age 20-40 and females age 30-40).

The holding tank 209 includes data describing advertisements assigned to advertisement placement opportunities (“content segments”) which are not yet cleared. The clearance optimizer system 102 or clearance optimization engine 201 thereof may use data included in the holding tank 209 to assign advertisements to advertisement placement opportunities. In some implementations, the advertisements which are not yet cleared have been soft accepted by a media content provider. In some implementations, the clearance optimizer system 102 or clearance optimization engine 201 may “un-assign” advertisements from advertisement placement opportunities which were soft accepted by a media content provider and remove the unassigned advertisements from the holding tank.

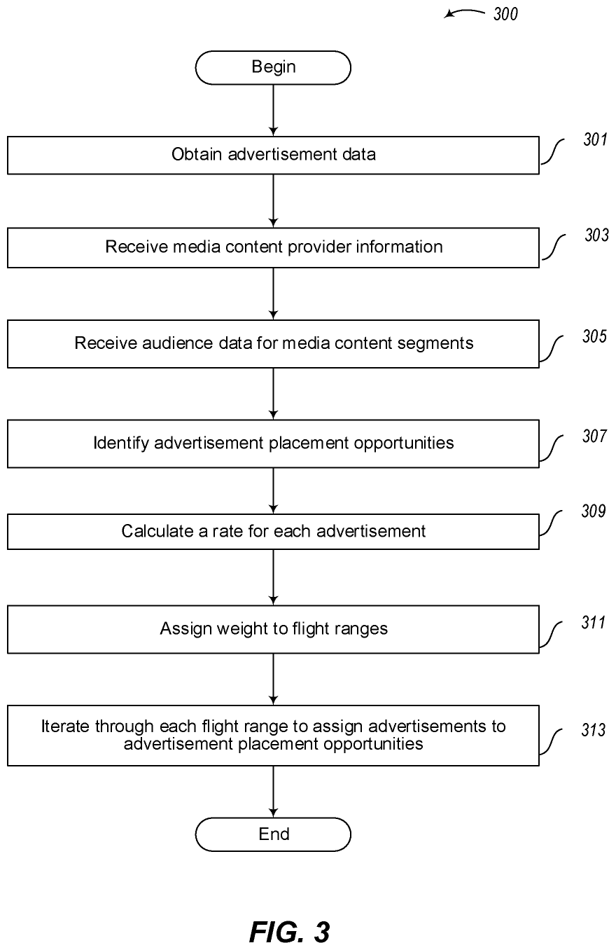

FIG. 3 is a flow diagram showing a method 300 of operating a clearance optimization engine 201 to assign advertisements to advertisement placement opportunities to ensure that the advertisements clear, according to one non-limiting illustrated implementation. After a start block, the method 300 begins at 301 where the clearance optimization engine 201 obtains advertisement data from an advertiser, or buyer. In some implementations, the clearance optimization engine 201 obtains the advertisement data from an AFI, such as the AFI 103 of FIG. 1. The advertisement data may include any of the data stored in the buyer campaigns 203.

At 303, the clearance optimization engine 201 receives media content provider information from one or more sellers, or media content providers. The media content provider information includes information describing media content segments, and advertisement placement opportunities within the media content segments. In some implementations, the media content provider information is obtained via a provider facing interface, such as the PFI 105 of FIG. 1. The media content provider information may include any of the data stored in the seller data 207.

At 305, the clearance optimization engine 201 receives audience data, such as the audience data 205, for media content segments obtained at 303. In some implementations, the clearance optimization engine 201 predicts what the audience data will be in the future after receiving the audience data.

At 307, the clearance optimization engine 201 identifies advertisement placement opportunities within the media content provider information. In some implementations, the media content provider identifies the advertisement placement opportunities via a provider facing user interface, or PFI 105.

At 309, the clearance optimization engine 201 calculates a price for each advertisement obtained in 301. In some implementations, the calculated price is a spot rate which is calculated based on a cost per mille, or “CPM” representing the cost per one thousand impressions. In some embodiments, the spot rate is calculated based on the budget for the advertisement and the target number of impressions for the advertisement.

At 311, the clearance optimization engine 201 assigns a weight to each flight range of a plurality of flight ranges. The flight ranges may be days, weeks, months, etc. In some implementations the flight ranges include one or more content segment collections. The content segment collections may include collections of media content based on the type of media content, such as, for example, sports, dramas, sitcoms, a specific show, program, or movie, events, such as sporting events, holiday events, parades, etc., or other types of media content. In some implementations, the content segment collections are organized based on time, such as the time content within the collection is aired or published, such as, for example, content aired between 4 PM and 10 PM being included in the same collection.

In some implementations, the clearance optimization engine 201 allocates resources, such as the buyer's budget, to each flight range. The allocated resources may then be allocated to content segment collections and content segments within the flight range based on buyer goals, such as: impression goals; target audience; CPM goals; or other buyer goals.

In some implementations, the clearance optimization engine 201 assigns the weights based on which flight ranges occur earlier than others. In some implementations, the weights are used in conjunction with the buyer's goal to prioritize placing advertisements in certain flight ranges. The weights may then be used to determine a “goal” for the flight range, such as staying within a certain budget, reaching a certain number of impressions, achieving a certain CPM, reaching a certain number of impressions for a target audience, etc. For example, if the buyer's goal is to reach 40,000 impressions, the clearance optimization engine 201 may weight the weeks such that 15,000 impressions are obtained in the first week, 12,000 in the second week, 8,000 in the third week, and 5,000 in the final week. Thus, in this example, the first week has a goal of reaching 15,000 impressions, the second week has a goal of reaching 12,000 impressions, and so on. In some implementations, the clearance optimization engine 201 may recalculate the weight based on a determination that the goal for one or more flight ranges was not achieved. For example, if 15,000 impressions were supposed to be obtained in the first week but only 13,000 can be obtained, the clearance optimization engine 201 may change the goals of the other flight ranges so the total number of impressions can still be obtained (e.g. the second week may be changed to have a 13,000 impression goal, and the third week may be changed to have a 9,000 impression goal).

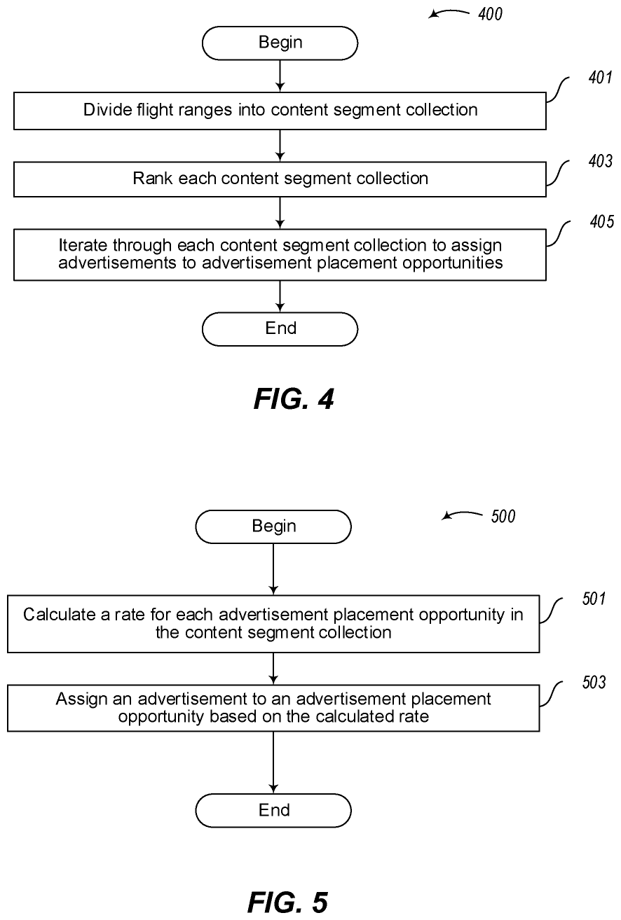

At 313, the clearance optimization engine 201 iterates through each flight range of the plurality of flight ranges to assign advertisements to the advertisement placement opportunities. In some implementations, the clearance optimization engine 201 uses the method described in FIG. 4 to iterate through each flight range. After 313, the method ends. In some implementations, at 313, when each advertisement placement opportunity in the plurality of flight ranges is taken, the clearance optimization engine 201 ends the method 300 early.

In some implementations, the clearance optimization engine 201 repeats the method 300 periodically. In some implementations, when repeating the method 300, the clearance optimization system assigns advertisements to the available advertisement placement opportunities, even if the available advertisement placement opportunities are assigned to advertisements in a different advertisement campaign or for a different buyer. In such implementations, the clearance optimization system re-assigns advertisements such that the advertisements are not competing with advertisements from another campaign for the same advertisement placement opportunity.

In some implementations, if the goal for the flight range is not achieved, such as a number of impressions not being reached, the clearance optimization engine 201 performs 313 again with only advertisements that were not assigned to advertisement placement opportunities. In some implementations, when each flight range is weighted and the goal for a flight range, or group of flight ranges, is not achieved, the clearance optimization engine 201 may re-weight the flight ranges before re-iterating through each flight range.

In some implementations, the clearance optimization engine 201 determines whether at least 309, 311, and 313 should be re-run with altered goals for the buyer campaign. The clearance optimization engine 201 may determine that the method should be re-run based on a determination that a determined number, or ratio, of the advertisements has a low chance of clearing. The clearance optimization engine 201 may adjust the goals for the buyer campaign and re-run at least 309, 311, and 313, and may generate a report indicating the changes in the goals and changes in the chances of clearing for each assigned advertisement. The clearance optimization engine 201 may present the generated report to the buyer through an AFI 103.

In some implementations, the clearance optimization engine re-runs at least 309, 311, and 313 based on a determination that one or more advertisements are not assigned to advertisement placement opportunities. In some implementations, the clearance optimization engine re-runs at least 309, 311, and 313 based on a determination that at least one advertisement placement opportunity is not assigned an advertisement. In some implementations, where the media content provider is able to soft accept assignments to advertisements for a flight range, content segment collection, or media content segment, the clearance optimization engine re-runs at least 309, 311, and 313 for at least one flight range, content segment collection, or media content segment which is not soft accepted.

FIG. 4 is a flow diagram showing a method 400 of operating a clearance optimization engine 201 to iterate through a plurality of content segment collections to assign an advertisement to an advertisement placement opportunity, according to one non-limiting illustrated implementation. After a start block, the method 400 begins at 401, where the clearance optimization engine 201 splits a time period into a plurality of content segment collections. The content segment collections may include media content segments which may be presented to a consumer during a certain time period, such as days, dayparts, hours, minutes, etc. Thus, for example, for a media content segment which may be presented to a consumer in a certain daypart, the daypart is represented by a content segment collection and the media content segment is included in that daypart.

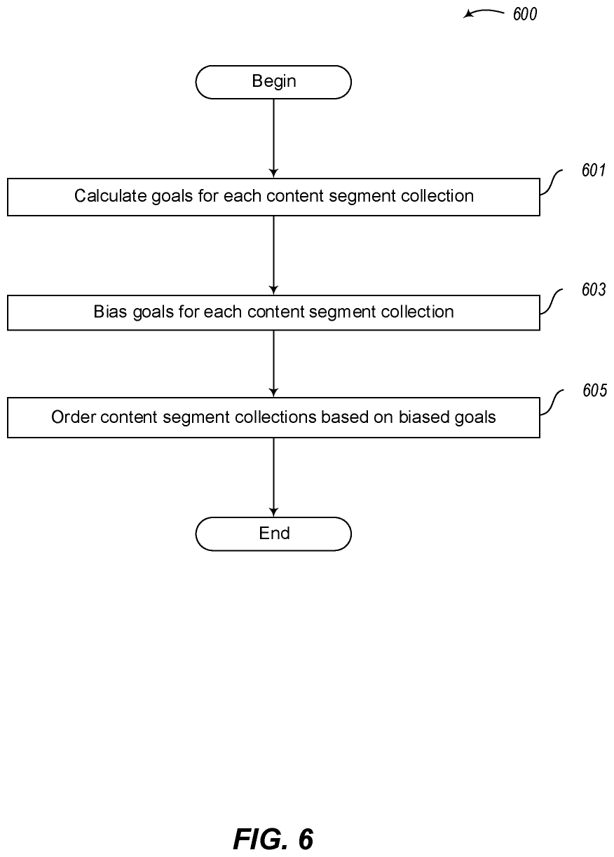

At 403, the clearance optimization engine 201 ranks each content segment collection. In some implementations, to rank the content segment collections, the clearance optimization engine 201 performs the method described in FIG. 6 discussed below. In some implementations, as part of ranking the content segment collections, the clearance optimization engine 201 generates a goal for the content segment collection, such as a number of impressions to reach, a certain budget being spent, a certain CPM being achieved, etc.

At 405, the clearance optimization engine 201 iterates through each content segment collection based on the rank to assign an advertisement to an advertisement placement opportunity, such as by performing the method described in FIG. 5 discussed below. In some implementations, the clearance optimization engine 201 continues to assign advertisements in the content segment collection until there are no remaining advertisement placement opportunities within the content segment collection. In some implementations, the clearance optimization engine 201 continues to assign advertisements in the content segment collection until the goal for the content segment collection is achieved. After 405, the method 400 ends.

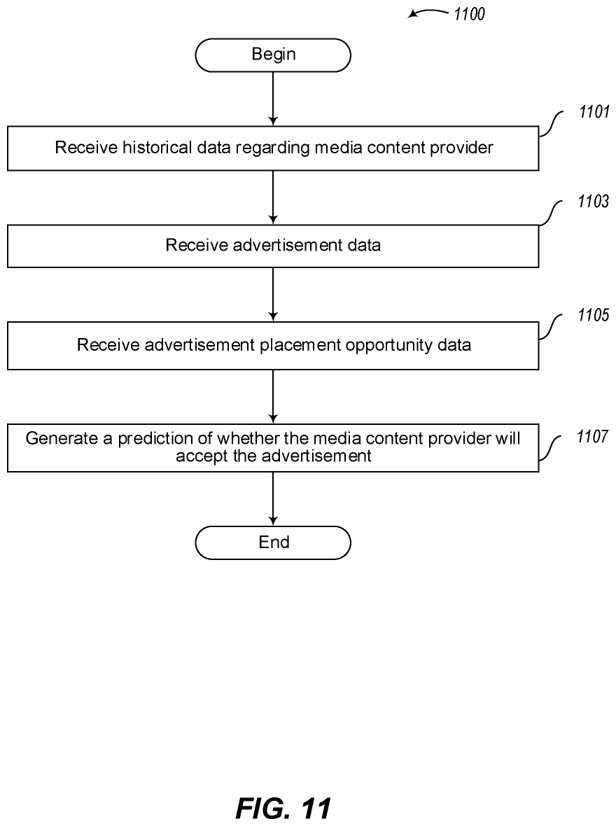

FIG. 5 is a flow diagram showing a method 500 of operating a clearance optimization engine 201 to iterate through a plurality of content segment collections to assign an advertisement to an advertisement placement opportunity, according to one non-limiting illustrated implementation. After a start block, the method 500 begins at 501, where the clearance optimization engine 201 calculates a rate, such as a spot rate, for each advertisement placement opportunity in the content segment collection. The spot rate may be calculated based on one or more of: the CPM, attributes of the campaign, attributes of the content segment collection, etc. In some implementations, the clearance optimization engine 201 additionally generates a prediction of whether the seller which created the advertisement placement opportunity will accept the assignment of the advertisement to the advertisement placement opportunity. In some implementations, the clearance optimization engine 201 generates the prediction based on historical data, such as the historical data from the seller, such as the historical data which may be included in the seller data 207. In some implementations, the clearance optimization engine 201 generates the prediction by using the process described in FIG. 11.

In some implementations, the clearance optimization engine 201 generates the prediction based on one or more “soft acceptances” or “soft rejections” by the seller. The seller may “soft accept” an assignment, indicating that they currently will clear the assignment, but may not in the future. A seller may choose not to accept an assignment after it has been soft accepted for a variety of reasons, such as, for example, a change in the advertisement placement opportunities the seller offers, another advertisement being assigned which the seller prefers to use instead, etc. The “soft reject” may work in a similar manner to the soft accept, where the seller indicates that they will reject the assignment, but may still accept in the future in the event of a change in circumstances. In some implementations, the historical data includes data describing the advertisements and advertisement placement opportunities which were soft accepted or soft rejected, and whether that assignment was finally accepted or rejected.

In some implementations, when the clearance optimization system detects that an attribute of an advertisement or an advertisement placement opportunity which was soft accepted or soft rejected has been changed, the clearance optimization system un-marks the assignment of the advertisement to the advertisement placement opportunity as accepted or rejected.

At 503, the clearance optimization engine 201 assigns an advertisement to the advertisement placement opportunity based on the calculated spot rate. In some implementations, the clearance optimization engine 201 assigns the advertisement to the advertisement placement opportunity based on the at least the calculated spot rate and the prediction that the assignment will clear.

In some implementations, the clearance optimization engine 201 may take into account a preference for an advertisement to be assigned to a certain advertisement placement opportunity, content segment, content segment collection, or flight range when assigning the advertisement. In some implementations, the clearance optimization engine 201 does not assign the advertisement to the advertisement placement opportunity when the preference cannot be honored. In some implementations, the clearance optimization engine 201 assigns the advertisement to a different advertisement placement opportunity when the preference cannot be honored.

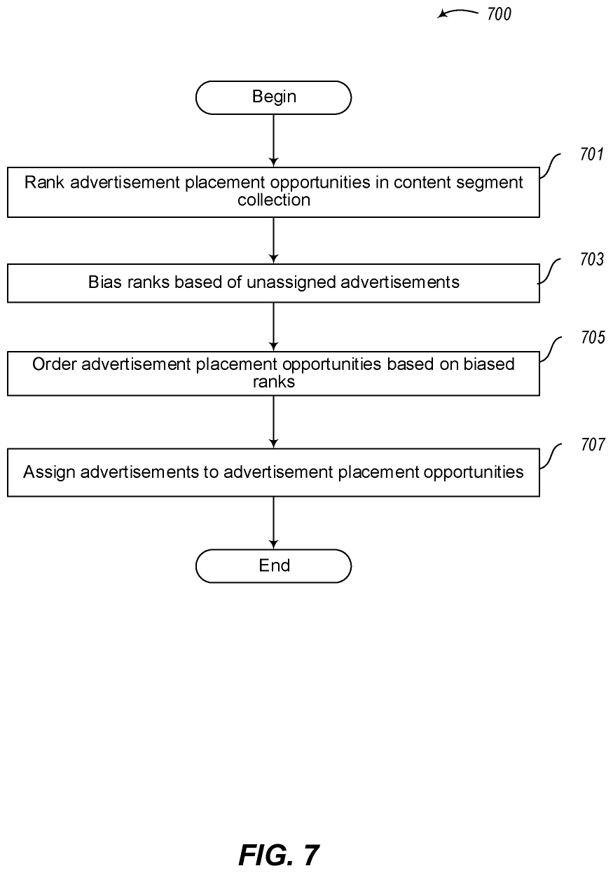

After 503, the method 500 ends. In some embodiments, the clearance optimization engine 201 assigns the advertisements by using the method described in FIG. 7 discussed below.

FIG. 6 is a flow diagram showing a method 600 of operating a clearance optimization engine 201 to assign a rank to each content segment collection, according to one non-limiting illustrated implementation. After a start block, the method 600 begins at 601, where the clearance optimization engine 201 calculates a goal for each content segment collection. In some implementations, the goal for a content segment collection is calculated based on one or more of: the capacity, or number of advertisement placement opportunities within the content segment collection; the number of impressions within the content segment collection; the audience demographic for the content segment collection; or other attributes of the content segment collection. In some implementations, the goals for the content segment collection include one or more of: impression goals, such as a total number of impressions; a CPM goal, such as reaching a threshold CPM; a budget goal, such as spending below or above a certain budget; etc.

At 603, the clearance optimization engine 201 biases goals for each content segment collection. In some implementations, the goals are biased based on which advertisement placement opportunities were selected in the past. In some implementations, the goals are biased based on a calculated spot rate for each content segment collection. In such implementations, the clearance optimization engine 201 may bias using fewer advertisement placement opportunities with a higher CPM better than using more advertisement placement opportunities with a lower CPM. For example, the clearance optimization engine 201 may prefer an advertisement placement opportunity with $12 CPM to obtain one thousand impressions over four separate advertisement placement opportunities with a $3 CPM to obtain one thousand impressions each.

At 605, the clearance optimization engine 201 ranks and orders the content segment collections based on the biased goals, allowing the clearance optimization engine 201 to iterate through the content segment collections based on the biased goals. In some implementations, the clearance optimization engine ranks the content segment collections based on one or more target demographics of the media content segments. In such implementations, the ranking may additionally be based on a comparison of the target demographics of the media content segments and a target demographic of the buyer's advertisement campaign. After 605 the method ends.

FIG. 7 is a flow diagram showing a method 700 of operating a clearance optimization engine 201 to assign an advertisement to an advertisement placement opportunity in a content segment collection, according to one non-limiting illustrated implementation. After a start block, the method 700 begins at 701, where the clearance optimization engine 201 ranks advertisement placement opportunities within the content segment collection. In some implementations, the clearance optimization engine 201 ranks the advertisement placement opportunities based on one or more attributes of the advertisement placement opportunity, such as: a CPM for the advertisement placement opportunity; a spot rate for the advertisement placement opportunity; a number of impressions for the advertisement placement opportunity; a capacity of the content segment collection, content segment, flight range, etc.; a measure of how often the advertisement placement opportunity has sold out in other flight ranges; historical clearance of the advertisement placement opportunity; an audience of the content segment, content segment collection, etc.; or other attributes of the advertisement placement opportunity. In some implementations, the clearance optimization engine 201 identifies a goal for each of the advertisement placement opportunities based on the rank and advertisement placement opportunity attributes.

At 703, the clearance optimization engine 201 biases the ranks of advertisement placement opportunities based on unassigned advertisements. In some implementations, the clearance optimization engine 201 biases the ranks based on identified goals for the advertisement placement opportunities and attributes of the unassigned advertisements. In some implementations, the clearance optimization engine 201 biases the ranks based in part on the audience of the content segment, or content segment collection, and the target audience of the buyer's campaign.

At 705, the clearance optimization engine 201 orders the advertisement placement opportunities based on the ranks.

At 707, the clearance optimization engine 201 assigns advertisements to the advertisement placement opportunities based on the ranks. In some implementations, the clearance optimization engine 201 takes into account hiatuses defined by the buyer to ensure that the advertisement does not air at certain days or times, when assigning advertisements to advertisement placement opportunities. In some implementations, the clearance optimization engine 201 takes into account a prediction of whether the advertisement will clear when assigning advertisements to advertisement placement opportunities. In some implementations, the clearance optimization engine 201 takes into account excluded programs or stations when assigning advertisements to advertisement placement opportunities.

In some implementations, the clearance optimization engine 201 does not assign an advertisement to an advertisement placement opportunity that was already soft accepted by a seller, unless there is a difference in the price between the two advertisements. In some implementations, the clearance optimization engine 201 updates the ranking of advertisement placement opportunities when a certain portion of advertisement placement opportunities are assigned an advertisement. In some implementations, the clearance optimization engine 201 continues assigning advertisements until the content segment collection does not have any advertisement placement opportunities remaining. In some implementations, the clearance optimization engine 201 continues assigning advertisements until the goal for the content segment collection has been met.

In some implementations, the clearance optimization engine 201 presents the assigned advertisements and advertisement placement opportunities to a buyer. In such implementations, the clearance optimization engine 201 may present the assigned advertisements along with an indication of their likelihood of clearing, such as by displaying a percentage, color-coding each presented assignment, and other methods of indicating data to a user. The clearance optimization engine 201 may use the process described in FIG. 11 to determine the likelihood that the advertisements will clear.

In some implementations, the clearance optimization engine 201 determines a confidence level representing the buyer's ability to buy the advertisement placement opportunity, based, at least in part, on the buyer's other assigned advertisements. The clearance optimization engine 201 may present the confidence level to a seller through the PFI 105.

After 707, the method 700 ends.

A non-limiting example of pseudocode used to describe one implementation of the functions of the clearance optimization system described in methods 300-700 is provided in Table 1 below.

```
TABLE 1
clearance optimizer:
inputs:
  buyer campaigns
  seller data
      formats, media content segments, effective dated
      media content segments and capacity, everything scheduled for 12-24mos, available and
preemptable units
      rate cards per media content segment, per week
output order:
  Goal:
      Goal is to create deals that will have a high chance of clearing hitting buyer's target.
    buyer campaign ->
          demo, target impressions day parts, single market, excluded properties, pcodes,
single length
          budget : total spend
    ratings data ->
          ratings date per station, inventory per week, projections
    seller side ->
          capacity per station, per media content segment, per week
          sellout level, per station, per media content segment, per week
          rates per station, per media content segment, per week, Floor
          product codes sellout per station, per media content segment, per week
    holding tank ->
          pressure - pending bookings, SWI buckets, algorithmic pressure, snapshotted every
24hrs, seller soft acceptance/clearance
  Selection Step:
      assign weight per week, front load as a pct of target impressions
      for each week W (across stations in the market)
      {
        calculate daypart goals if none, as pct of capacity x targeted impressions x demo
        bias daypart goals depending on running totals of new units per inventory from prior
weeks
        bias daypart CPM goals based on higher daypart market CPM goals,
            accumulated from media content segment within day part
          for each daypart D
          {
            (across all stations) calculate media content segment ranks, bias rank per
deviation from CPM,
              number of impressions, capacity, pcode sellout, market place historical
clearance per rate bucket
            bias ranks depending on new units from previous loop
            select media content segment for new units, randomization step all best within
5% with no pruning
            prune media content segments on week mask to account for hiatuses
            assignment already soft accepted/accepted wins as long as it has capacity and
rate has NOT decreased
            if (digging into lower 75% ranked media content segments) reshuffle, update
media content segment ranking
            repeat until no more capacity or daypart goal achieved
          }
          if week goal not achieved, exclude out of capacity, re-rank, redistribute targets to
remaining dayparts, loop
          if no capacity left, exit
          update running weekly totals, run next week
      }
```

FIG. 8 is a flow diagram showing a method 800 of operating a clearance optimization engine 201 to assign advertisements from multiple buyers to advertisement placement opportunities provided by multiple sellers, according to one non-limiting illustrated implementation. In some implementations, the clearance optimization engine 201 performs the method 800 after performing the method 300 for each buyer of a plurality of buyers. After a start block, the method 800 begins at 801, where the clearance optimization engine 201 obtains a set of advertisements from multiple advertisers.

At 803, the clearance optimization engine 201 ranks the content segment collections. In some implementations, the clearance optimization engine 201 ranks the content segment collections based on the number of advertisement placement opportunities in the content segment collection which are not assigned to advertisements (“open capacity”). In some implementations, the clearance optimization engine 201 ranks the content segment collections based on the number of buyers which have an advertisement assigned to advertisement placement opportunities in the content segment collection (“demand”). In some implementations, the clearance optimization engine 201 ranks the content segment collections based on both open capacity and demand.

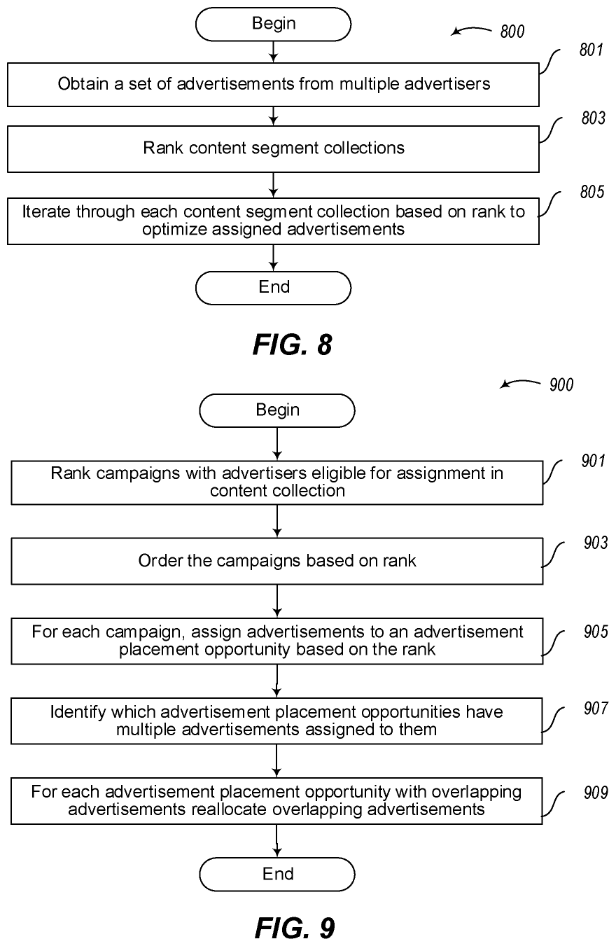

At 805, the clearance optimization engine 201 iterates through each content segment collection to optimize the assigned advertisements. In some implementations the clearance optimization engine 201 optimizes the assigned advertisements by ensuring that each advertisement placement opportunity has only one advertisement assigned to it, that is, preventing advertisements from “overlapping” by being assigned to the same advertisement placement opportunity. In some implementations, the clearance optimization system 201 performs the method described in FIG. 9 to iterate through each content segment collection. After 805, method 800 ends.

FIG. 9 is a flow diagram showing a method 900 of operating a clearance optimization engine 201 to iterate through content segment collections to optimize assigned advertisements, according to one non-limiting illustrated implementation. The method 900 begins, after a start block, at 901, where the clearance optimization engine 201 ranks campaigns with advertisements which can be assigned to advertisement placement opportunities within a content segment collection. In some implementations, the campaigns are ranked based on one or more of the length of the advertisements in the campaign, the target demographics of the campaign, the targeted impressions of the campaign, the CPM of the campaign, or other attributes of the campaign. In some implementations, the campaign attributes are used to calculate a “spend per second,” which is a measure of how much the buyer pays per second of advertisement time, and the campaigns are ranked based on the spend per second. In some implementations, the campaigns are ranked such that campaigns with a higher budget are ranked higher than other campaigns. In some implementations, campaigns are ranked based on their average spot rate for a day part. In some implementations, campaigns are ranked based on how close the advertisements for the campaign are to being presented to a consumer by the media content provider. In some implementations, the campaigns are ranked based on the dates of the campaign. For example, a campaign which is ending soon may be higher ranked than a campaign that just began to ensure that the campaign which is ending soon is able to reach all of its goals.

At 903, the clearance optimization engine 201 orders the ranked campaigns by rank. At 905, for each campaign, the clearance optimization engine 201 assigns eligible advertisements in the campaign, i.e. advertisements which can be assigned to advertisement placement attributes, to an advertisement placement opportunity based on the rank of the campaign. In some implementations, the clearance optimization engine 201 assigns the eligible advertisements in the campaign by using method 300. In such implementations, the clearance optimization engine 201 may bias the advertisements based on historical data for sellers, such as data describing acceptances and rejections of advertisements. In some implementations, the clearance optimization engine 201 only assigns advertisements to advertisement placement opportunities if their probability, or “likelihood,” of clearance has exceeded a certain threshold.

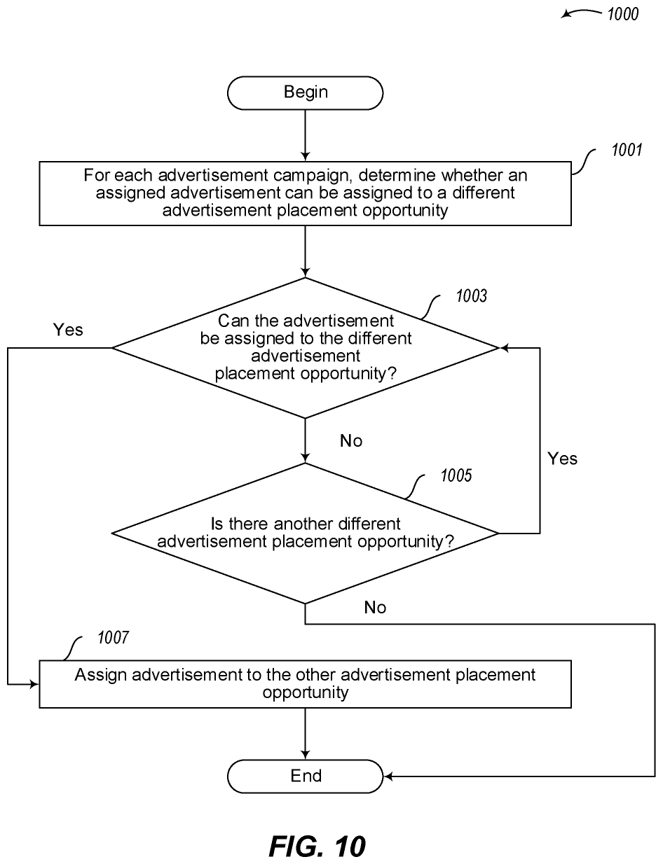

At 907, the clearance optimization engine 201 identifies which advertisement placement opportunities have multiple advertisements assigned to them. At 909, for each advertisement placement opportunity with overlapping advertisements, reallocate the overlapping advertisements to other advertisement placement opportunities. Thus, only advertisement placement opportunities with competing advertisements are re-allocated, and advertisement placement opportunities with no competing advertisements are left alone, allowing the clearance optimization engine 201 to re-allocate advertisements by without having to consume excess computer resources to re-allocate every advertisement. In some implementations, step 909 is performed by using the method described in FIG. 10. After 909, the method 900 ends.

FIG. 10 is a flow diagram showing a method 1000 of operating a clearance optimization engine 201 to reallocate advertisements to other advertisement placement opportunities, according to one non-limiting illustrated implementation. The method 1000 begins, after a start block, at 1001, where the clearance optimization engine 201 determines, for each advertisement in each advertisement campaign, whether an assigned advertisement can be assigned to another advertisement placement opportunity which does not have an advertisement assigned to it. In some implementations the clearance optimization engine 201 additionally determines whether the advertisement placement opportunity can be assigned to an advertisement in a different campaign.

At 1003, if the clearance optimization engine 201 determines that the advertisement can be assigned to another advertisement placement opportunity, the method proceeds to 1007, otherwise, the method proceeds to 1005. In some implementations, at 1003, the clearance optimization engine 201 uses the method described in FIG. 11 to generate a prediction of whether the advertisement will clear when assigned to a new advertisement placement opportunity. The clearance optimization engine 201 may use the prediction to choose which advertisement to assign to the advertisement placement opportunity.

At 1005, the clearance optimization engine 201 determines whether there is another different advertisement placement opportunity. If the clearance optimization engine determines that there is another different advertisement placement opportunity, the method returns to 1003, otherwise the method ends. In some implementations, the clearance optimization engine 201 searches for the different advertisement placement opportunity based on the advertisement's attributes, such as the budget, the impression goal, the target demographic, and other attributes of the advertisement.

In some implementations, when performing 1005, the other advertisement placement opportunity is already assigned to an advertisement. For example, the clearance optimization engine 201 may choose to replace an advertisement when the advertisement being replaced has a lower budget than the other advertisement. In some implementations, the clearance optimization engine 201 tracks which campaigns and buyers have been replaced. In some implementations, the clearance optimization engine 201 uses the tracked campaigns and buyers to ensure that the same campaign or buyer is not always replaced with other advertisements.

At 1007, the clearance optimization engine 201 assigns the advertisement to the other advertisement placement opportunity which does not have an advertisement assigned to it. In some implementations, after 1007, the clearance optimization engine 201 determines whether any campaigns still have advertisements which are unassigned. In such implementations, the clearance optimization engine 201 uses the method 400 to assign the advertisements to advertisement placement opportunities for each campaign with unassigned advertisements, while taking into account all of the advertisements that are already assigned to advertisement placement opportunities. After 1007, the method ends.

A non-limiting example of pseudocode used to describe one implementation of the functions of the clearance optimization system described in methods 800-1000 is provided in Table 2 below.

```
TABLE 2
  Fitness Goal: rank deals by spend that is most likely to clear, per market, per daypart
skew
  Cross optimizer biases chances of clearance to the highest ranking deals
  This can cause low rank deals to starve or even fail
  Universe: data model (includes a copy holding tank)
  Goal: find max spend x clearance for the capacity
    front load week
    for each week
    {
      rank dayparts by lowest open capacity vs highest demand
      for each daypart
      {
        make list campaign competing for daypart capacity, sort by highest spend
per second (function of length, demo impressions, CPM)
        allocate the best spending campaigns first
        for each campaign in list
        {
          following same steps as single buyer optimizer, bias depending on
acceptance/rejection data for seller
          media content segments filtered on week mask hiatus eligibility for
campaign
          allocate media content segments, allocate over 90% confidence
        }
        make list campaigns competing for daypart capacity, sort by highest spend
per second (function of length, demo impressions, CPM)
        for each incoming deal in list
        {
          recursive: find competing campaigns with capacity to reallocate
              {
                for each (competing campaigns, incoming unallocated media
content segments)
                  if competing unit can find new media content segment then
move
                  {
                    allocate previously consumed media content segment to
incoming campaigns
                  }
                if nothing could be reallocated
                  for each (competing campaign, incoming unallocated media
content segments)
                    call recursive step for this campaign
                }
            if nothing could be reallocated
                cannibalize lower lowest spend competing campaign
                try not to punish consistently same campaign
        }
        Commit allocations to holding tank
        for each campaign short on allocations
            run single buyer optimizer
      }
    }
```

FIG. 11 is a flow diagram showing a method 1100 used by the clearance optimization engine 201 to generate a prediction of whether an advertisement assigned to an advertisement placement opportunity will clear, according to one non-limiting illustrated implementation. The method 1100 begins, after a start block, at 1101, where the clearance optimization engine 201 receives historical data regarding the media content provider. The historical data includes data describing advertisement attributes of advertisements that cleared when assigned to an advertisement placement opportunity, as well as data describing the advertisement placement opportunity to which the advertisement was assigned. In some implementations, the historical data includes data describing assignments of advertisements to advertisement placement opportunities which a media content provider has accepted (“historical acceptance data”). In some implementations, the historical data includes data describing assignments of advertisements to advertisement placement opportunities which a media content provider has rejected (“historical rejection data”).

At 1103, the clearance optimization engine 201 receives advertisement data, including advertisement attribute data, describing an advertisement. At 1105, the clearance optimization engine 201 receives data describing an advertisement placement opportunity.

At 1107, the clearance optimization engine 201 generates a prediction of whether a media content provider will clear the advertisement assigned to the advertisement placement opportunity based on the historical data, advertisement data, and advertisement placement opportunity data. In some implementations, the clearance optimization engine 201 uses statistical analysis to generate the prediction. In some implementations, the clearance optimization engine 201 applies the advertisement data and the advertisement placement opportunity data to an artificial intelligence or machine learning model to generate the prediction of whether the media content provider will accept the advertisement.

In some embodiments, the prediction is generated by determining an offered rate that the seller typically accepts. The clearance optimization engine 201 may obtain a rate offered by a buyer, and compare that to the offered rate that the seller typically accepts. The clearance optimization engine 201 may determine that the seller is likely to accept the rate offered by the buyer based on a determination that the rate offered by the buyer is within a determined range of the rate typically accepted by the seller. For example, the rate offered by the buyer may be $10 and the rate typically accepted by the seller may be $11. The clearance optimization engine 201 may determine that the seller would accept offers within $1.50 rate based on the analysis performed in 1107, and generate a prediction that the seller would accept the $10 CPM offered by the buyer.

After 1107, the method 1100 ends.

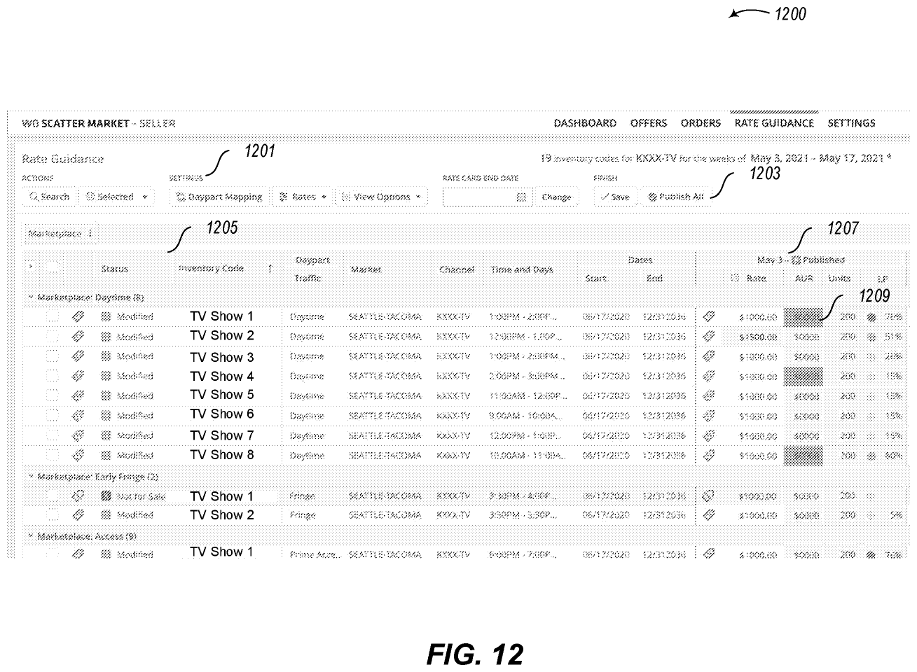

FIG. 12 is a display diagram depicting a sample seller rate definition screen 1200 presented by the PFI 105, according to one non-limiting illustrated implementation. The seller rate definition screen 1200 includes settings dropdowns 1201, a publish all button 1203, a media content segment information section 1205, and an advertisement placement opportunity section 1207. The advertisement placement opportunity section may include a heat map 1209 which indicates the demand for advertisement placement opportunities relative to other advertisement placement opportunities provided by the seller. The settings dropdowns 1201 include a variety of settings to define and modify advertisement placement opportunities offered by the seller and media content segments provided to a media consumer by the seller. The publish all button 1203 allows a seller to publish the advertisement placement opportunities to make them available for allocation to a buyer's advertisement. The media content segment information section 1205 presents data corresponding to each of the media content segments provided to media consumers. In this non-limiting example, a daypart refers to the time of day that the content is set to air and an inventory code represents an identifier for a media content segment. The advertisement placement opportunity section 1207 indicates the advertisement placement opportunities corresponding to media content segments in the media content segment information section 1205. In this non-limiting example, the seller may define rates for advertisement placement opportunities, including a “rate guidance” and preferred rates, by adjusting the rates in the advertisement placement opportunity section 1207. In such an example, the clearance optimization engine 201 will take the rate guidance, preferred rate, or other defined rate, into account when assigning advertisements to the advertisement placement opportunity. In some implementations, the seller is additionally able to define a range of rates to be used as a “rate guidance.”

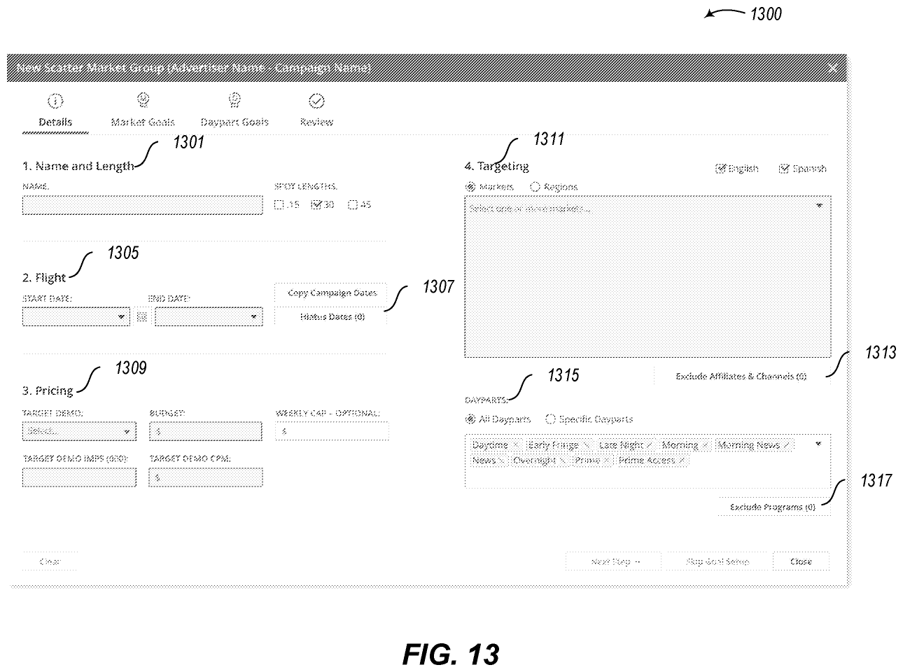

FIG. 13 is a display diagram depicting a sample buyer campaign definition screen 1300 presented by the AFI 103, according to one non-limiting illustrated implementation. The buyer campaign definition screen 1300 includes a name and length section 1301, a flight section 1305, a hiatus dates button 1307, a pricing section 1309, a targeting section 1311, a content provider exclusion button 1313, a daypart section 1315, and a program exclusion button 1317.

A buyer uses the buyer campaign definition screen 1300 to define a new advertisement campaign and define advertisement attributes for the campaign. The name and length section 1301 receives data indicating a name for the campaign and one or more spot lengths for the advertisements in the campaign. In some implementations, the name and length section 1301 includes additional user interface elements for specifying a CPM per spot length. The flight section 1305 receives data indicating when the advertisement campaign will be airing. The hiatus date button 1307 presents a user interface used by a buyer to define dates where the advertisement campaign will not be airing. The pricing section 1309 allows a buyer to define target demographics, a budget, a CPM, a weekly cap, target impressions, etc. The targeting section 1311 allows a user to choose certain markets or regions to search for advertisement placement opportunities. The exclude affiliates button 1313 presents a user interface used by a buyer to define markets, regions, or media content providers to exclude from searching for advertisement placement opportunities. The dayparts section 1315 allows a buyer to specify dayparts to search for advertisement placement opportunities. The exclude programs button 1317 presents a user interface used by a buyer to define media content segments to exclude from searching for advertisement placement opportunities.

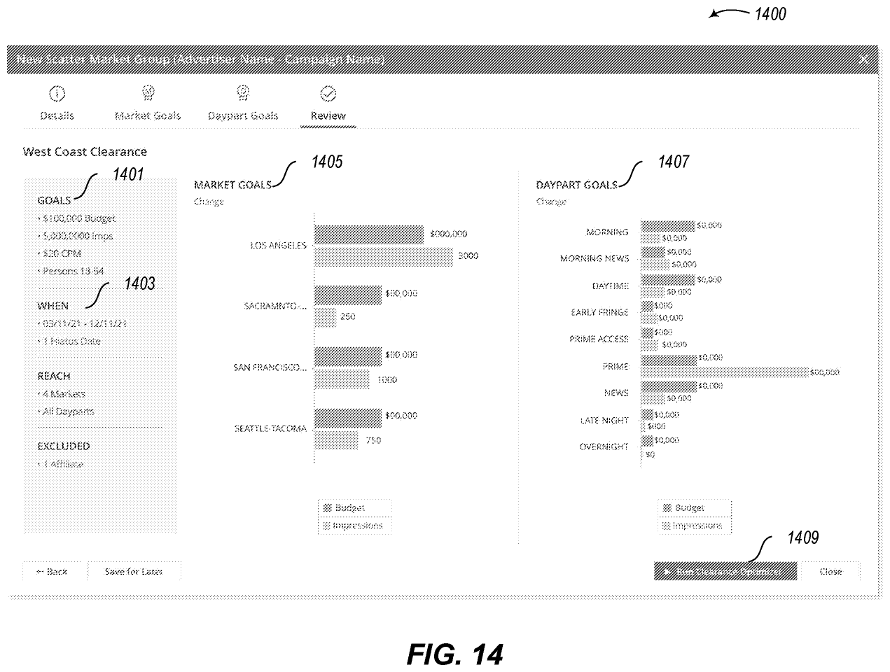

FIG. 14 is a display diagram depicting a sample buyer goal screen 1400 presented by the AFI 103, according to one non-limiting illustrated implementation. The buyer goal screen 1400 includes a goals section 1401, a flight range section 1403, a market goals section 1405, a daypart goals section 1407, and a run optimizer button 1409. The buyer goal screen displays goals defined by the buyer for their advertisement campaign. The buyer may define their goals by using another user interface (not shown). The goals section 1401 presents information describing the goals defined by the buyer, such as budget goals, impression goals, target demographics, a CPM goal, etc. The flight range section 1403 presents information describing when the advertisement campaign runs, as well as hiatus dates for the campaign. The market goals section 1405 presents the progress of goals across multiple markets. For example, the Seattle-Tacoma market has a goal of 750 impressions and a budget of less than $100,000. The daypart goals section 1407 presents the progress of goals in certain dayparts. The run optimizer button 1409 uses the clearance optimization engine to assign advertisements in the campaign to advertisement placement opportunities to fulfill the goals of the advertisement campaign and guarantee clearance of the advertisements.

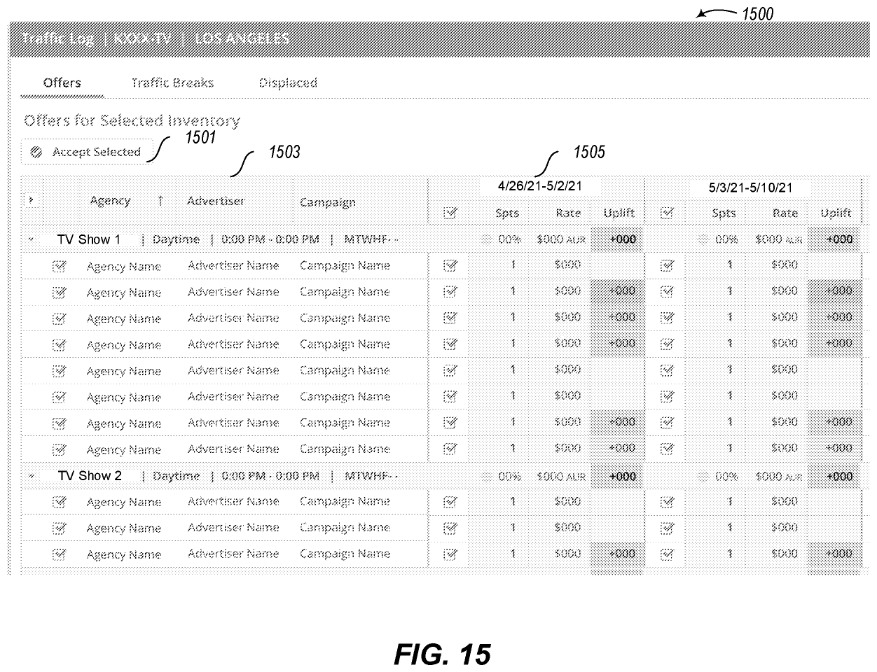

FIG. 15 is a display diagram depicting a sample assignment acceptance screen 1500 presented by the PFI 105, according to one non-limiting illustrated implementation. The assignment acceptance screen 1500 includes an accept button 1501, a media content segment section 1503, and a date section 1505. A media content provider uses the assignment acceptance screen 1500 to accept, reject, soft accept, or soft reject, assignments of advertisements to advertisement placement opportunities.

Activating the accept button 1501 causes the clearance optimization engine 201 to accept the selected advertisement assignments for the media content provider. The media content segment section 1503 presents information related to the media content segments associated with the media content provider. The date section 1505 presents information related to each advertisement placement opportunity for each media content segment, as well as information related to the advertisement assigned to the media content segment.

In some implementations, the clearance optimization system uses the sample assignment acceptance screen 1500 to obtain an indication of preferred assignments for flight ranges. The preferred assignments may be assignments for a flight range in the future. For example, where a flight range is a week, the seller may accept the assignments for the current week, and mark one or more assignments for a future week, e.g. two weeks from the current week, as preferred assignments. In some implementations, the clearance optimization system takes this preference into account when assigning advertisements in the future week, such as by adjusting the likelihood that the media content provider will accept the assignment and that the advertisement will clear.

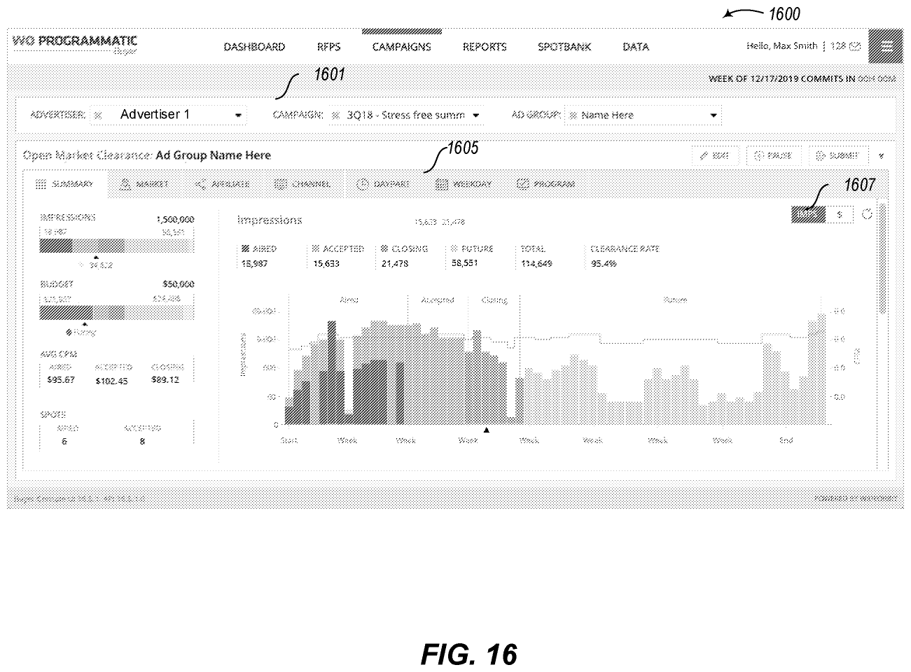

FIG. 16 is a display diagram depicting a sample campaign progress dashboard 1600 presented by the AFI 103, according to one non-limiting illustrated implementation. The campaign progress dashboard 1600 includes an advertiser identification section 1601, an advertisement progress section 1605, and a budget and impressions selector 1607. The campaign progress dashboards presents to a buyer the progress of the campaigns goals, including running totals related to the campaign goals. The advertiser identification section 1601 includes data indicating an advertiser and an advertisement campaign. The advertisement progress section 1605 includes a graph representation of the status of one or more goals for the advertisement campaign, a summary section representing the progress of the campaign goals, as well as options to view the campaign goals in the context of certain markets, dayparts, days, media content programs, channels, etc. The impressions selector 1607 allows a buyer to select between a graph displaying impression goals and a graph displaying budget goals.

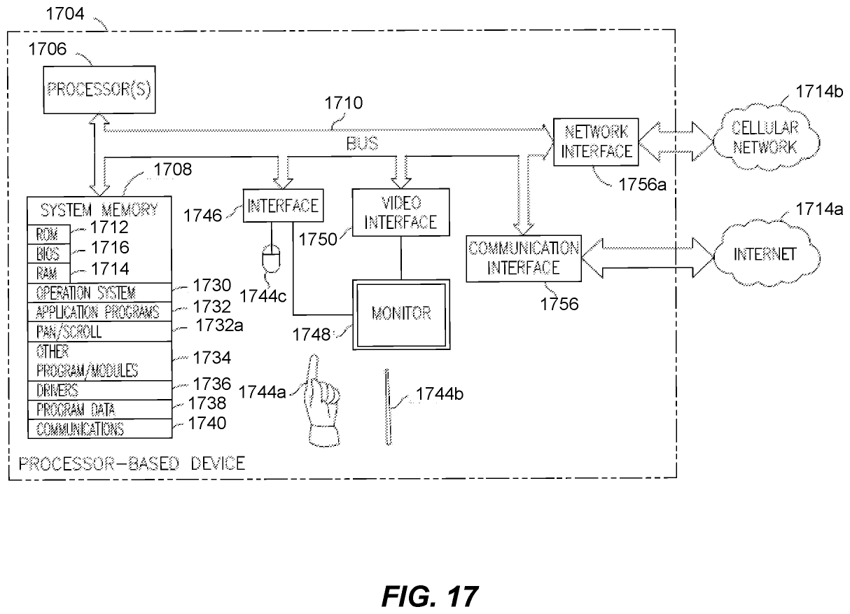

FIG. 17 shows a processor-based device 1704 suitable for implementing the various functionality described herein. Although not required, some portion of the implementations will be described in the general context of processor-executable instructions or logic, such as program application modules, objects, or macros being executed by one or more processors. Those skilled in the relevant art will appreciate that the described implementations, as well as other implementations, can be practiced with various processor-based system configurations, including handheld devices, such as smartphones and tablet computers, wearable devices, multiprocessor systems, microprocessor-based or programmable consumer electronics, personal computers (“PCs”), network PCs, minicomputers, mainframe computers, and the like.

The processor-based device 1704 may include one or more processors 1706, a system memory 1708 and a system bus 1710 that couples various system components including the system memory 1708 to the processor(s) 1706. The processor-based device 1704 will at times be referred to in the singular herein, but this is not intended to limit the implementations to a single system, since in certain implementations, there will be more than one system or other networked computing device involved. Non-limiting examples of commercially available systems include, but are not limited to, ARM processors from a variety of manufactures, Core microprocessors from Intel Corporation, U.S.A., PowerPC microprocessor from IBM, Sparc microprocessors from Sun Microsystems, Inc., PA-RISC series microprocessors from Hewlett-Packard Company, 68xxx series microprocessors from Motorola Corporation.

The processor(s) 1706 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 17 are of conventional design. As a result, such blocks need not be described in further detail herein, as they will be understood by those skilled in the relevant art.

The system bus 1710 can employ any known bus structures or architectures, including a memory bus with memory controller, a peripheral bus, and a local bus. The system memory 1708 includes read-only memory (“ROM”) 1712 and random access memory (“RAM”) 1714. A basic input/output system (“BIOS”) 1716, which can form part of the ROM 1712, contains basic routines that help transfer information between elements within processor-based device 1704, such as during start-up. Some implementations may employ separate buses for data, instructions and power.

The processor-based device 1704 may also include one or more solid state memories, for instance Flash memory or solid state drive (SSD) 1718, which provides nonvolatile storage of computer-readable instructions, data structures, program modules and other data for the processor-based device 1704. Although not depicted, the processor-based device 1704 can employ other nontransitory computer- or processor-readable media, for example a hard disk drive, an optical disk drive, or memory card media drive.

Program modules can be stored in the system memory 1708, such as an operating system 1730, one or more application programs 1732, other programs or modules 1734, drivers 1736 and program data 1738.

The application programs 1732 may, for example, include panning/scrolling 1732a. Such panning/scrolling logic may include, but is not limited to logic that determines when and/or where a pointer (e.g., finger, stylus, cursor) enters a user interface element that includes a region having a central portion and at least one margin. Such panning/scrolling logic may include, but is not limited to logic that determines a direction and a rate at which at least one element of the user interface element should appear to move, and causes updating of a display to cause the at least one element to appear to move in the determined direction at the determined rate. The panning/scrolling logic 1732a may, for example, be stored as one or more executable instructions. The panning/scrolling logic 1732a may include processor and/or machine executable logic or instructions to generate user interface objects using data that characterizes movement of a pointer, for example data from a touch-sensitive display or from a computer mouse or trackball, or other user interface device.

The system memory 1708 may also include communications programs 1740, for example a server and/or a Web client or browser for permitting the processor-based device 1704 to access and exchange data with other systems such as user computing systems, Web sites on the Internet, corporate intranets, or other networks as described below. The communications programs 1740 in the depicted implementation is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 17 as being stored in the system memory 1708, the operating system 1730, application programs 1732, other programs/modules 1734, drivers 1736, program data 1738 and server and/or browser 1740 can be stored on any other of a large variety of nontransitory processor-readable media (e.g., hard disk drive, optical disk drive, SSD and/or flash memory).

A user can enter commands and information via a pointer, for example through input devices such as a touch screen 1748 via a finger 1744a, stylus 1744b, or via a computer mouse or trackball 1744c which controls a cursor. Other input devices can include a microphone, joystick, game pad, tablet, scanner, biometric scanning device, etc. These and other input devices (i.e., “I/O devices”) are connected to the processor(s) 1706 through an interface 1746 such as touch-screen controller and/or a universal serial bus (“USB”) interface that couples user input to the system bus 1710, although other interfaces such as a parallel port, a game port or a wireless interface or a serial port may be used. The touch screen 1748 can be coupled to the system bus 1710 via a video interface 1750, such as a video adapter to receive image data or image information for display via the touch screen 1748. Although not shown, the processor-based device 1704 can include other output devices, such as speakers, vibrator, haptic actuator, etc.

The processor-based device 1704 may operate in a networked environment using one or more of the logical connections to communicate with one or more remote computers, servers and/or devices via one or more communications channels, for example, one or more networks 1714a, 1714b. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, the processor-based device 1704 may include one or more wired or wireless communications interfaces 1714a, 1714b (e.g., cellular radios, WI-FI radios, Bluetooth radios) for establishing communications over the network, for instance the Internet 1714a or cellular network.

In a networked environment, program modules, application programs, or data, or portions thereof, can be stored in a server computing system (not shown). Those skilled in the relevant art will recognize that the network connections shown in FIG. 17 are only some examples of ways of establishing communications between computers, and other connections may be used, including wirelessly.

For convenience, the processor(s) 1706, system memory 1708, network and communications interfaces 1714a, 1714b are illustrated as communicably coupled to each other via the system bus 1710, thereby providing connectivity between the above-described components. In alternative implementations of the processor-based device 1704, the above-described components may be communicably coupled in a different manner than illustrated in FIG. 17. For example, one or more of the above-described components may be directly coupled to other components, or may be coupled to each other, via intermediary components (not shown). In some implementations, system bus 1710 is omitted and the components are coupled directly to each other using suitable connections.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating a computer system, comprising:
receiving an indication of one or more advertisements, each advertisement including one or more advertisement placement attributes;
calculating a price for each advertisement based on the one or more advertisement placement attributes;
receiving media content provider information for a media content provider, the media content provider information including identification of a plurality of media content segments;
receiving audience data for the media content provider, the audience data including an audience prediction for each media content segment of the plurality of media content segments;
identifying one or more advertisement placement opportunities for each media content segment of the plurality of media content segments;
assigning a weight to each flight range of a plurality of flight ranges; and
iterating through each flight range based on the assigned weight, including, for each flight range of the plurality of flight ranges:
dividing the flight range into a plurality of content segment collections, each content segment collection including at least one media content segment of the plurality of media content segments, each media content segment including at least one advertisement placement opportunity of the one or more advertisement placement opportunities;
ranking each content segment collection of the plurality of content segment collections, wherein the rank for each content segment collection is determined based on at least one attribute of the at least one media content segments included in each content segment collection; and
iterating through each content segment collection based on the rank, including, for each content segment collection of the plurality of content segment collections:
calculating a price for each advertisement placement opportunity for the respective content segment collection based on the audience data and the media content provider information;
determining a likelihood that a media content provider will accept the assignment of an advertisement of the one or more advertisements to an advertisement placement opportunity of the at least one advertisement placement opportunities of the content segment collection based, at least in part, on the calculated price of the advertisement and the calculated price of the advertisement placement opportunity; and
assigning the advertisement of the one or more advertisements to at least one advertisement placement opportunity of the one or more advertisement placement opportunities for the content segment collection based on the determined likelihood that the media content provider will accept the assignment.

2. The method of claim 1, wherein each advertisement placement opportunity comprises a spot rate, a capacity, and audience demographic data.

3. The method of claim 2, wherein calculating the price for each advertisement placement opportunity for the respective content segment collection further comprises:
calculating the price for the advertisement placement opportunity for the content segment collection based on the audience data, the spot rate, the capacity, the audience demographic data, and the media content provider information.

4. The method of claim 1, wherein the advertisement placement attributes further comprise at least one of a target demographic, a target number of impressions, a spot length, a total budget, a product code, one or more excluded media content providers, or one or more excluded media content segment collections.

5. The method of claim 1, further comprising:
generating the audience prediction for one or more media content segment collections based on the received audience data; and
calculating the price for each advertisement placement opportunity for the respective content segment collection based on the audience data, the media content provider information, and the audience prediction.

6. The method of claim 1, further comprising:
identifying at least one advertisement of the one or more advertisements which are assigned to at least one advertisement placement opportunity of the one or more advertisement placement opportunities and which have not been accepted by a media content provider; and
storing an indication of the identified at least one advertisement of the one or more advertisements in a holding tank.

7. The method of claim 1, wherein each flight range of the plurality of flight ranges is one week, wherein each content segment collection of the plurality of content segment collections is a daypart, and wherein each media content segment is a program.

8. The method of claim 1, further comprising:
receiving historical acceptance data;
determining whether to soft accept the assignment of one or more assigned advertisements based on the historical acceptance data; and
marking the one or more assigned advertisements as accepted based on the determination of whether to soft accept the assignment of the one or more assigned advertisements.

9. The method of claim 1, further comprising:
receiving historical rejection data;
determining whether to soft accept the assignment of one or more assigned advertisements based on the historical rejection data; and
marking the one or more assigned advertisements as accepted based on the determination of whether to soft accept the assignment of the one or more assigned advertisements.

10. The method of claim 1, further comprising:
receiving historical acceptance data;
receiving historical rejection data;
determining whether to soft accept the assignment of one or more assigned advertisements based, at least in part, on the historical acceptance data and historical rejection data; and
marking the one or more assigned advertisements as accepted based on the determination of whether to soft accept the assignment of the one or more assigned advertisements.

11. The method of claim 1, further comprising:
presenting to a media content provider, via a media content provider-facing user interface, an option to soft reject the assignment of one or more assigned advertisements;
obtaining user input, via the media content provider-facing user interface, indicating that at least one assigned advertisement of the one or more assigned advertisements is soft rejected; and
marking the at least one assigned advertisement as rejected.

12. The method of claim 1, further comprising:
presenting to a media content provider, via a media content provider-facing user interface, an option to soft accept the assignment of one or more assigned advertisements;
obtaining user input, via the media content provider-facing user interface, indicating that at least one assigned advertisement of the one or more assigned advertisements is soft accepted; and
marking the at least one assigned advertisement as accepted.

13. The method of claim 12, further comprising:
determining whether one or more conditions have occurred, wherein the one or more conditions comprise at least one of:
a determination that a provider of the at least one assigned advertisement has rejected the assignment of at least one advertisement of the at least one assigned advertisements;
a determination that a price of at least one advertisement has changed; or
a determination that at least one additional advertisement has been received; and
unmarking the at least one assigned advertisement as accepted, such that the at least one assigned advertisement is able to be re-assigned to at least one advertisement placement opportunity.

14. The method of claim 1, further comprising:
identifying a current flight range of the plurality of flight ranges, wherein the current flight range occurs before each of the other flight ranges in the plurality of flight ranges;
presenting to a media content provider, via a media content provider-facing user interface, an option to mark at least one assignment of the one or more assigned advertisements included in a flight range which is not the current flight range as a preferred assignment;
obtaining user input, via the media content provider-facing user interface, indicating that at least one assignment of the one or more assigned advertisements is a preferred assignment; and
calculating the price for each advertisement placement opportunity for the respective content segment collection based on the audience data, the media content provider information, and the one or more preferred assignments.

15. The method of claim 1, wherein assigning a weight to each flight range of the plurality of flight ranges further comprises:
determining which flight ranges of the plurality of flight ranges will occur sooner than other flight ranges of the plurality of flight ranges; and
adjusting the weights of each flight range based on the determination of which flight ranges of the plurality of flight ranges occur sooner than other flight ranges of the plurality of flight ranges.

16. The method of claim 1, further comprising:
assigning an impression goal to each flight range based on the weight assigned to each of the flight ranges of the plurality of flight ranges.

17. The method of claim 1, wherein the advertisement placement attributes include a goal, and each content segment collection is ranked based at least in part on the goal for each advertisement included in the content segment collection.

18. The method of claim 1, further comprising:
determining whether one or more assigned advertisements are accepted by the media content provider;
extracting historical data from each advertisement placement opportunity of the one or more assigned advertisements accepted by the media content provider; and
determining the likelihood that the media content provider will accept the assignment of an advertisement to an advertisement placement opportunity based on at least the extracted historical data, the calculated price of the advertisement, and the calculated price of the advertisement placement opportunity.

19. The method of claim 1, further comprising:
calculating the price of the advertisement placement opportunity based on a CPM of the advertisement placement opportunity;
obtaining a rate guidance from a media content provider; and
determining the likelihood that the media content provider will accept the assignment of an advertisement to an advertisement placement opportunity based on at least the rate guidance, the calculated price of the advertisement, and the calculated price of the advertisement placement opportunity.

20. The method of claim 1, further comprising:
identifying a spot rate for each advertisement placement opportunity;
identifying a spot rate for each advertisement, based on at least the advertisement placement attributes; and
ranking each advertisement placement opportunity based on the identified spot rate for the advertisement placement opportunity and the identified spot rate for each advertisement, such that advertisement placement opportunities with a higher rank are more likely to be assigned an advertisement.

21. The method of claim 18, wherein ranking each advertisement placement opportunity comprises:
determining whether the spot rate for each advertisement is within a determined range of the spot rate for each advertisement placement opportunity, such that the advertisement placement opportunity is ranked higher based on a determination that the spot rate for the advertisement is within the determined range.

22. The method of claim 1, wherein iterating through each flight range further comprises:
determining a goal for each flight range, wherein the goal for each flight range includes obtaining a threshold number of impressions;
identifying one or more advertisements not assigned to an advertisement placement opportunity;
identifying one or more content segment collections with advertisement placement opportunities that are not assigned to an advertisement;
re-ranking the one or more content segment collections; and
iterating through each content segment collection to assign an advertisement of the one or more advertisements not assigned to an advertisement placement opportunity to an advertisement placement opportunity not assigned to an advertisement.

23. The method of claim 1, further comprising:
determining a predicted rate of clearance for each assigned advertisement based on the advertisement placement attributes for the assigned advertisement and the media content provider information; and
presenting the predicted rate of clearance for at least one of the assigned advertisements to a user via an advertiser-facing user interface.

24. The method of claim 1, further comprising:
presenting, via a media content provider-facing user interface, an option to soft accept one or more flight ranges of the plurality of flight ranges, wherein soft accepting the flight range includes soft accepting the assigned advertisements for advertisement placement opportunities in the flight range;
receiving user input, via the media content provider-facing user interface, an indication of one or more flight ranges which are soft accepted;
determining which flight ranges are not soft accepted; and
re-iterating through each flight range which is not soft accepted.

25. The method of claim 1, further comprising:
receiving second media content provider information for one or more additional media content providers;
receiving audience data for each media content provider of the one or more additional media content providers; and
identifying one or more advertisement placement opportunities for a plurality of media content segment collections for each media content provider of the additional media content providers.

26. The method of claim 1, wherein ranking the content collections further comprises:
identifying one or more target demographics of each media content segment; and
ranking the content segment collections based at least in part on the one or more target demographics of each media content segment.

27. A system to optimize clearance of advertisements in linear mediacasts, the system comprising:
at least one nontransitory processor-readable storage medium that stores at least one of instructions or data; and
at least one processor communicatively coupled to the at least one nontransitory processor-readable storage medium, in operation, the at least one processor:
receives an indication of one or more advertisements, each advertisement including one or more advertisement placement attributes;
calculates a price for each advertisement based on the one or more advertisement placement attributes;
receives media content provider information for a media content provider, the media content provider information including identification of a plurality of media content segments;
receives audience data for the media content provider, the audience data including an audience prediction for each media content segment of the plurality of media content segments;
identifies one or more advertisement placement opportunities for each media content segment of the plurality of media content segments;
assigns a weight to each flight range of a plurality of flight ranges; and
iterates through each flight range based on the assigned weight, including, for each flight range of the plurality of flight ranges:
divides the flight range into a plurality of content segment collections, each content segment collection including at least one media content segment of the plurality of media content segments, the at least one media content segment including at least one advertisement placement opportunity of the one or more advertisement placement opportunities;
ranks each content segment collection of the plurality of content segment collections, wherein the rank for each content segment collection is determined based on at least one attribute of the at least one media content segments included in each content segment collection; and
iterates through each content segment collection based on the rank, including, for each content segment collection of the plurality of content segment collections:
calculates a price for each advertisement placement opportunity for the respective content segment collection based on the audience data and the media content provider information;
determining a likelihood that a media content provider will accept the assignment of an advertisement of the one or more advertisements to an advertisement placement opportunity of the at least one advertisement placement opportunities of the content segment collection based, at least in part, on the calculated price of the advertisement and the calculated price of the advertisement placement opportunity; and
assigns the advertisement of the one or more advertisements to at least one advertisement placement opportunity of the one or more advertisement placement opportunities for the content segment collection based on the determined likelihood that the media content provider will accept the assignment.

28. A nontransitory processor-readable storage medium that stores at least one of instructions or data, the instructions or data, when executed by at least one processor, cause the at least one processor to:
receive an indication of one or more advertisements, each advertisement including one or more advertisement placement attributes;
calculate a price for each advertisement based on the one or more advertisement placement attributes;
receive media content provider information for a media content provider, the media content provider information including identification of a plurality of media content segments;
receive audience data for the media content provider, the audience data including an audience prediction for each media content segment of the plurality of media content segments;
identify one or more advertisement placement opportunities for each media content segment of the plurality of media content segments;
assign a weight to each flight range of a plurality of flight ranges; and
iterate through each flight range based on the assigned weight, including, for each flight range of the plurality of flight ranges:
divide the flight range into a plurality of content segment collections, each content segment collection including at least one media content segment of the plurality of media content segments, the at least one media content segment including at least one advertisement placement opportunity of the one or more advertisement placement opportunities;
rank each content segment collection of the plurality of content segment collections, wherein the rank for each content segment collection is determined based at least one attribute of the at least one media content segments included in each content segment collection; and
iterate through each content segment collection based on the rank, including, for each content segment collection of the plurality of content segment collections:
calculate a price for each advertisement placement opportunity for the respective content segment collection based on the audience data and the media content provider information;
determine a likelihood that a media content provider will accept the assignment of an advertisement of the one or more advertisements to an advertisement placement opportunity of the at least one advertisement placement opportunities of the content segment collection based, at least in part, on the calculated price of the advertisement and the calculated price of the advertisement placement opportunity; and
assign the advertisement of the one or more advertisements to at least one advertisement placement opportunity of the one or more advertisement placement opportunities for the content segment collection based on the determined likelihood that the media content provider will accept the assignment.

29. A method of operating a computer system comprising:
receiving an indication of one or more assigned advertisements, each assigned advertisement being assigned to an advertisement placement opportunity;
identifying one or more competing advertisements in the one or more assigned advertisements, wherein competing advertisements are advertisements assigned to an advertisement placement opportunity that has at least one other assigned advertisement; and
for each competing advertisement in the identified one or more competing advertisements:
identifying one or more advertisement placement opportunities which do not have an assigned advertisement;
determining, for each of the identified advertisement placement opportunities, a likelihood that the competing advertisement will clear if the competing advertisement is assigned to the identified advertisement placement opportunity; and
assigning the competing advertisement to an identified advertisement placement opportunity based on the determined likelihood that the competing advertisement will clear.
